(19) United States
(12) Patent Application Publication
(10) Pub. No.: US 2012/0327790 A1
(43) Pub. Date: Dec. 27, 2012

(54) APPARATUSES AND METHODS FOR COORDINATING CIRCUIT SWITCHED (CS) SERVICES IN PACKET TRANSFER MODE (PTM)

(75) Inventors: Chen-Hsuan Lee, Taipei City (TW); Chin-Han Wang, Taipei City (TW); Chu-Ching Yang, Taipei City (TW); Chang-Kuan Lin, Kaohsiung City (TW); Chih-Yung Shih, Hsinchu City (TW); Chun-Sheng Lee, Zhubei City (TW); Chia-Yi Huang, Taichung City (TW); Yi-Ting Chang, Hsinchu City (TW); Sian-Jheng Wong, Yizhu Township (TW); Shih-Hsin Chien, Banciao City (TW)

(73) Assignee: MEDIATEK INC., Hsin-Chu (TW)

(21) Appl. No.: 13/168,259

(22) Filed: Jun. 24, 2011

(51) Int. Cl. H04W 88/16; H04W 72/04

(52) U.S. Cl. 370/252; 370/310; 370/329

(57) ABSTRACT

A wireless communications device is provided with a baseband chip capable of coordinating operations between circuit-switched (CS) and packet-switched (PS) services with different subscriber identity cards. The baseband chip is configured to perform a packet switched (PS) data service associated with a second service network, sacrifice a portion of data transceiving from/to the second service network to monitor a channel associated with a first service network during the PS data service, so as to receive message from the first service network or maintain mobility in the first service network.

### BACKGROUND OF THE INVENTION

1. Field of the Invention

The invention generally relates to the coordination of operations between communications services, and more particularly, to the coordination of the operations between CS and PS services with different subscriber identity cards in a packet transfer mode (PTM).

2. Description of the Related Art

With growing demand for ubiquitous computing and networking, various wireless communication technologies have been developed, such as the Global System for Mobile communications (GSM) technology, General Packet Radio Service (GPRS) technology, Enhanced Data rates for Global Evolution (EDGE) technology, Universal Mobile Telecommunications System (UMTS) technology, Wideband Code Division Multiple Access (W-CDMA) technology, Code Division Multiple Access 2000 (CDMA 2000) technology, Time Division-Synchronous Code Division Multiple Access (TD-SCDMA) technology, Worldwide Interoperability for Microwave Access (WiMAX) technology, Long Term Evolution (LTE) technology, Long Term Evolution-Advanced (LTE-A) technology, Time-Division LTE (TD-LTE) technology, and others. Generally, a cellular phone only supports one wireless communication technology and provides a user the flexibility of mobile communications at all times via the supported wireless communication technology, regardless of his/her geographic location. Specifically in today's business world, a cellular phone is becoming a necessary business tool for conducting business conveniently. For business people, having an additional cellular phone exclusive for business matters is a common choice, since they need to conduct business while being out of the office or even out of the city/country. Others may find having an additional cellular phone as a good way to save/control the budget for wireless service charges (including phone services and/or data services). However, having two or more than two cellular phones may be troublesome when one has to switch frequently between the cellular phones and carry around all the cellular phones with himself/herself. In order to provide a convenient way of having multiple subscriber numbers, dual-card or multiple-card cellular phones have been developed, which generally have two or more wireless communication modules for respectively performing wireless transmission and reception with an individual subscriber number. The dual-card or multiple-card design allows the wireless communication modules to be active simultaneously and allows calls to be received on either subscriber numbers associated with one of the wireless communication modules at any time. Thus, a dual-card or multiple-card cellular phone may be used for business and personal use with separate subscriber numbers and bills, or for travel with the second subscriber number for the country visited.

For the dual-card or the multiple-card cellular phones with one single transceiver, only one wireless communication module is allowed to obtain network resources using the single transceiver, while another wireless communication module has no control over the single transceiver. Specifically, the wireless communication module with no control over the single transceiver is not aware that the single transceiver is occupied by another wireless communication module, because the two or more wireless communication modules operate independently and lack a proper communication mechanism there-between. For example, a dual-card cellular phone may be configured such that the single transceiver is occupied by the first wireless communication module for performing a PS data service, e.g. the Multimedia Messaging Service (MMS), Instant Messaging Service (IMS), file transfer via file transfer protocol (FTP), Web browsing, or others. When a Mobile Terminated (MT) call for the second wireless communication module is requested by a network associated with the second wireless communication module, the MT call may be missed since the second wireless communication module has no access to the single transceiver, and the second wireless communication module is not aware of the incoming MT call since the network cannot page the second wireless communication module.

Therefore, it is desirable to have a flexible way of managing the operations between the multiple wireless communication modules for multiple subscriber identity cards, so that the second wireless communication module can receive the MT calls from the network while the first wireless communication module performs a PS data service.

### BRIEF SUMMARY OF THE INVENTION

Accordingly, embodiments of the invention provide apparatuses and methods for coordinating the operations between CS and PS services with a respective service network. In one aspect of the invention, a wireless communications device with a baseband chip is provided. The baseband chip is configured to perform a packet switched (PS) data service associated with a second service network, sacrifice a portion of data transceiving from/to the second service network to monitor a channel associated with a first service network during the PS data service, so as to receive message from the first service network or maintain mobility in the first service network.

In another aspect of the invention, a method for coordinating operations between CS and PS services with different service networks in a wireless communications device is provided. The method comprises the steps of performing, by a baseband chip, a packet switched (PS) data service associated with a second service network; sacrificing, by a baseband chip, a portion of data transceiving from/to the second service network to monitor a channel associated with a first service network during the PS data service, so as to receive message from the first service network or maintain mobility in the first service network.

Other aspects and features of the present invention will become apparent to those with ordinarily skill in the art upon review of the following descriptions of specific embodiments of the apparatuses and methods for coordinating the operations between CS and PS services with a respective service network.

### BRIEF DESCRIPTION OF DRAWINGS

The invention can be more fully understood by reading the subsequent detailed description and examples with references made to the accompanying drawings, wherein:

FIG. 1 is a block diagram of a wireless communications environment according to an embodiment of the invention;

FIG. 2 is a diagram illustrating an exemplary Call Control (CC) scheme in a GSM system;

FIG. 3 is a diagram illustrating an exemplary LA update procedure for a GSM network;

FIG. 4 is a diagram illustrating the PDP context activation procedure initialized by an MS;

FIG. 5 is a block diagram illustrating the hardware architecture of an MS according to an embodiment of the invention;

FIG. 6 shows a block diagram illustrating the hardware architecture of an MS according to another embodiment of the invention;

FIG. 7 is a block diagram illustrating the hardware architecture of an MS coupled with four subscriber identity cards and a single antenna according to another embodiment of the invention;

FIG. 8 is a block diagram illustrating the software architecture of an MS according to an embodiment of the invention;

FIG. 9 is a diagram illustrating channel occupancy time for an MS that monitors a 2G CS paging channel in a 3G packet transfer mode according to an embodiment of the invention;

FIG. 10 is a diagram illustrating channel occupancy time for an MS that monitors a 3G CS paging channel in a 2G packet transfer mode according to an embodiment of the invention;

FIG. 11 is a diagram illustrating channel occupancy time for a UE that makes 2G power measurements in a 3G packet transfer mode according to an embodiment of the invention;

FIG. 12 is a flow chart illustrating a method for coordinating the operations between the protocol stack handlers 910 and 920 using the software architecture of FIG. 8 according to an embodiment of the invention;

FIG. 13 is a message sequence chart illustrating the method for coordinating the operations between the protocol stack handlers 910 and 920 according to the embodiment of FIG. 12;

FIG. 14 is a flow chart illustrating the method for coordinating the operations between the protocol stack handlers 910 and 920 using the software architecture of FIG. 9 according to another embodiment of the invention;

FIG. 15 is a message sequence chart illustrating the coordination of the operations between the protocol stack handlers 910 and 920 according to the embodiment of FIG. 14;

FIG. 16 is a block diagram illustrating the software architecture of an MS according to another embodiment of the invention;

FIGS. 17A and 17B are a flow chart illustrating a method for coordinating the operations between the protocol stack handlers 910 and 920 using the software architecture of FIG. 16 according to an embodiment of the invention;

FIGS. 18A and 18B are a message sequence chart illustrating the coordination of the operations between the protocol handlers 910 and 920 according to the embodiment of FIGS. 17A and 17B;

FIG. 19 is a flow chart illustrating the method for coordinating the operations between the protocol stack handlers 910 and 920 using the software architecture of FIG. 16 according to another embodiment of the invention;

FIGS. 20A and 20B are a message sequence chart illustrating the coordination of the operations between the protocol stack handlers 910 and 920 according to the embodiment of FIG. 19;

FIG. 21 is a block diagram illustrating the software architecture of an MS according to yet another embodiment of the invention;

FIGS. 22A and 22B are a flow chart illustrating a method for coordinating the operations between the protocol stack handlers 910 and 920 using the software architecture of FIG. 21 according to an embodiment of the invention; and

FIG. 23 is a flow chart illustrating the method for coordinating the operations between the protocol stack handlers 910 and 920 using the software architecture of FIG. 21 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

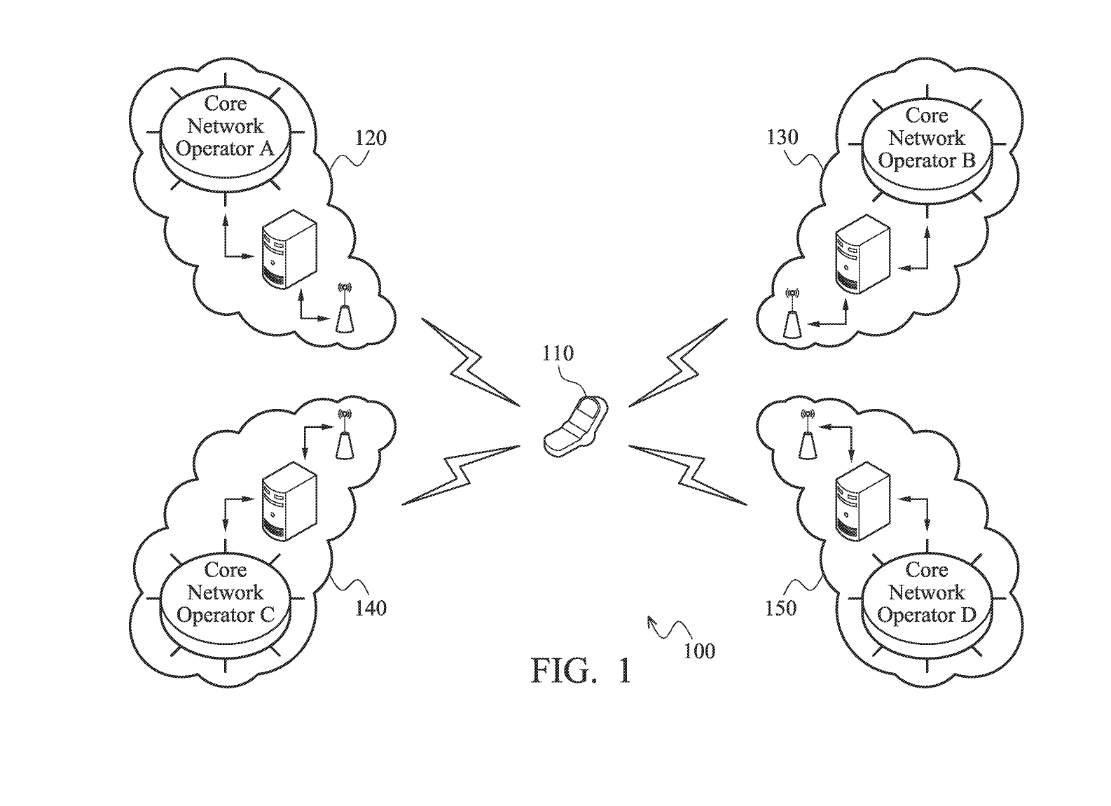

FIG. 1 is a block diagram of a wireless communications environment according to an embodiment of the invention. The wireless communications environment 100 comprises a mobile station (MS) 110, and service networks 120, 130, 140 and 150. The MS 110 may wirelessly communicate with the service networks 120, 130, 140 and 150 with one to four separate subscriber numbers and/or four separate subscriber identities, after camping on one to four cells. The cell may be managed by a node-B, a base station (BS), an advanced BS (ABS), an enhanced BS (EBS) or others. However, the communication is only allowed to be performed with one of the four service networks 120, 130, 140 and 150 at a given time. The service networks 120, 130, 140 and 150 may be in compliance with any of the GSM/GPRS/EDGE, WCDMA, CDMA 2000, UMTS, TD-SCDMA, WiMAX, LTE, LTE-A, and TD-LTE technologies. The subscriber numbers may be provided by four separate subscriber identity cards (or a user name and a password in the case of WiMAX) in compliance with the specifications of the technologies employed by the service networks 120, 130, 140 and 150. For example, the service network 120 may be a GSM/GPRS/EDGE system, and correspondingly, one of the subscriber identity cards may be a Subscriber Identity Module (SIM) card, while the service network 130 may be a WCDMA, UMTS, LTE, or TD-LTE system and correspondingly, the other one of the subscriber identity cards may be a Universal SIM (USIM) card. The service network 140 may be a CDMA 2000 system and correspondingly, one of the subscriber identity cards may be a Removable User Identity Module (R-UIM) card, while the service network 150 may be a TD-SCDMA system and correspondingly, the other one of the subscriber identity cards may be a CDMA subscriber Identity Module (CSIM) card. Additionally, the MS 110 may prompt the user for user name and/or password or a dongle may be required when one of the service networks 120, 130, 140, or 150 is a WiMAX network, and no subscriber identity card may be required for the WiMAX service network in the MS 110. The four subscriber identity cards equipped by the MS 110 may be taken as an example and is not limited thereto. The MS 110 may also be equipped with 2, 3, or more subscriber identity cards and be adapted to 2, 3, or more wireless telecommunication technologies according to different design requirements of the MS 110.

The MS 110 wirelessly accesses the Internet resources, such as e-mail transmissions, Web browsing, file upload/download, instant messaging, streaming video, voice over IP (VoIP) or others, or makes a wireless phone call. In addition, a computer host or a notebook may connect/couple to the MS 110 and wirelessly access Internet resources therethrough. The MS 110 may be operated in idle mode or dedicated mode in GSM systems for the inserted SIM card. In idle mode, the MS searches for or measures a Broadcast Control Channel (BCCH) with a better signal quality from a cell provided by a specific service network, or is synchronized to the BCCH of a specific cell, wherein it is continuously ready to perform a random access procedure on a Random Access Channel (RACH) for requesting for a dedicated channel. In the dedicated mode, the MS 110 occupies a physical channel and tries to synchronize therewith, and establishes logical channels and performs switching therethrough. As the MS 110 is equipped with one or more USIM cards, the MS 110 may be operated in an idle mode and connected mode, for a WCDMA or TD-SCDMA network, for each inserted USIM card.

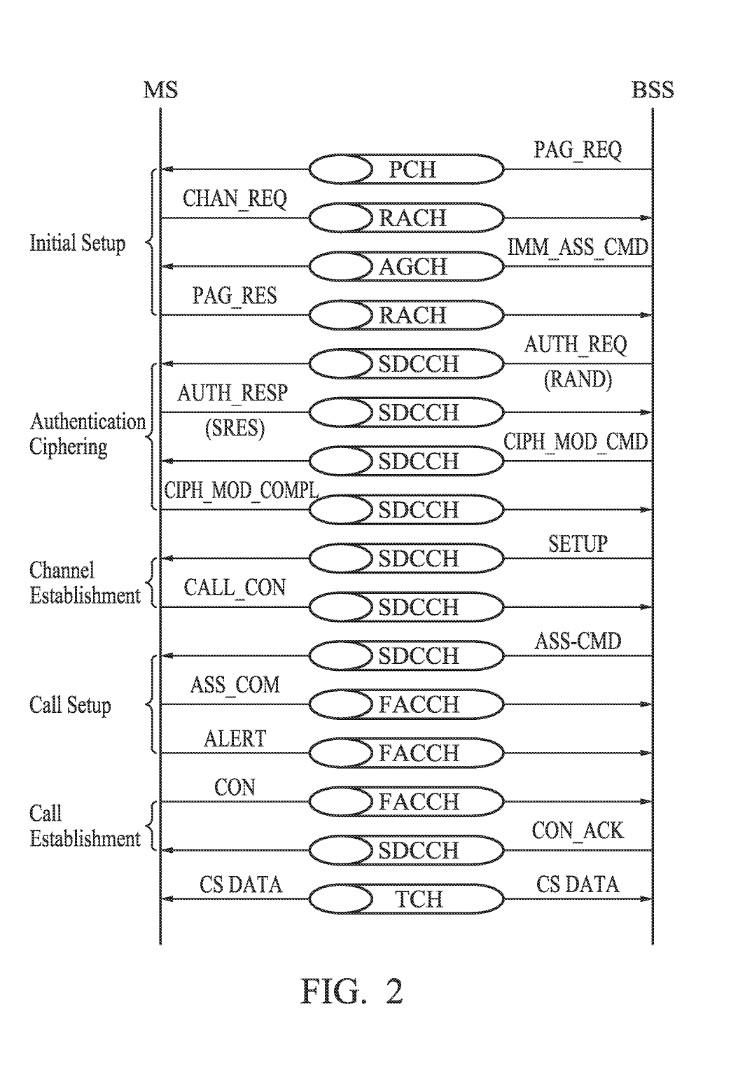

Take a GSM system for example, referring to FIG. 2, FIG. 2 is a diagram illustrating an exemplary Call Control (CC) scheme in a GSM system. The CC is one of the Connection Management (CM) entities and may comprise procedures to establish, control, and terminate calls. The term Mobile Terminated (MT) Call refers to when the MS is the receiver of a call which may be originated from the outside of the Public Land Mobile Network (PLMN) or within the same PLMN. If there is an attempt to make a call to an MS, i.e. Mobile Terminated (MT) call, the Mobile Switching Center/Visitor Location Register (MSC/VLR) may order the Base Station Sub-network (BSS) to page the MS. Since the MSC/VLR does not exactly know which Base Station Controller (BSC) and Base Transceiver Station (BTS) of the BSS the MS is monitoring, the paging message will be sent out across the entire Location Area (LA). The MS may receive the Page Request (PAG_REQ) on the Paging Channel (PCH) and recognize that the paging message is intended for it, based on a Temporary Mobile Subscriber Identity (TMSI) or an International Mobile Subscriber Identity (IMSI). Then, the MS may send a Channel Request (CHAN_REQ) message on the Random Access Channel (RACH) to the BSS, and the BSS may respond on the Access Grant Channel (AGCH) by sending an Immediate Assignment Command (IMM_ASS_COM) message which assigns a Stand-Alone Dedicated Control Channel (SDCCH) to the MS for system signals transmission prior to Traffic Channel (TCH) allocation. At this point, the network does not know that the MS is the target MS that it is paging, and the network only knows that this MS wants access to the network. The MS immediately switches to the assigned SDCCH once the IMM_ASS_COM is received and sends a Paging Response (PAG_RES) message on the SDCCH, which lets the network know that the MS is responding to its paging message, wherein, up to this point, the initial set up for the MT call is completed.

Before the network provides any services to the MS, the network requires the MS to authenticate itself. The BSS sends an Authentication Request (AUTH_REQ) message including a random number (RAND) to the MS, the RAND is a 128-bit random challenge generated by the Home Location Register (HLR) for authentication. The MS calculates a proper signed response (SRES) based on the RAND it was given and sends the SRES to the BSS in an Authentication Response (AUTH_RESP) message. The BSS verifies the SRES when received, and if the SRES is correct, the MS is authenticated and allowed access to the network. Once the MSC/VLR has authenticated the MS, the MSC/VLR may order the BSS and MS to switch to a cipher mode using a CIPH_MOD_CMD message. Once the MS is in the encryption mode, the VLR will normally assign a new TMSI to the MS.

Once the MS is authenticated and in the encryption mode, the MSC may initialize channel establishment by sending a SETUP message to the BSS, and the BSS would forward the SETUP message to the MS on the assigned SDCCH. The SETUP message may include a Calling Line Identification Presentation (CLIP), which is essentially the caller ID. The MS may respond to the SETUP message by sending a Call Confirmed (CALL_CON) message, which indicates that the MS is able to establish the requested connection, and the CALL_CON message may be relayed by the BSS up to the MSC. The BSS may then proceed with a call setup procedure by sending an Assignment Command (ASS_CMD) message, which assigns a Traffic Channel (TCH) to the MS on the assigned SDCCH. The MS may immediately switch to the TCH following receipt of the ASS_CMD message and respond to the BSS with an Assignment Complete (ASS_COM) message on the FACCH (all signaling that occurs on the traffic channel actually occurs on a FACCH, which is a time slot that is stolen from the TCH and used for signaling). The MS begins ringing once it has established the TCH. The MS may send an ALERT message to the MSC on the FACCH, and the BSS forwards the ALERT message through the PSTN (if in different PSTN) to the calling party, wherein the caller would hear a line ringing. Once a user of the MS answers the call (by pressing the OK button or touching the screen and so on), the MS will send a Connect (CON) message to the MSC, wherein the Connect message would be forwarded back to the caller's switch to activate the call. The MSC sends a Connect Acknowledge CON_ACK message to the MS and the call is established. CC of the WCDMA, TD-SCDMA or UMTS systems is similar to that of the GSM systems and is omitted herein for brevity.

The MS may perform power measurements to candidate cells and use the measured signal quality and/or signal strength as an input for handover and cell reselection decisions. In the case where the MS is in the idle mode, the list of the neighboring GSM cell Broadcast Control Channel (BCCH) frequencies may be transmitted with its own BCCH frequency and the MS may listen for the BCCH frequencies and perform a power measurement for the GSM Received Signal Strength Indication (RSSI) of the BCCH, which is a wideband received power within the GSM channel bandwidth. In the case of a UMTS or WCDMA network, although the same wideband frequency is used by adjacent cells, the cells are physically identified by their different scrambling codes, and the MS may constantly monitor the Common Pilot Channel (CPICH) for power levels (e.g. Ec/No, Received Signal Code Power (RSCP), and so on). The information may then be used to assess whether the UMTS/WCDMA cell should be added to the active set for cell reselection. The MS may make a cell reselection decision depending on different cell reselection criteria corresponding to each radio access technology (RAT). For example, for a GSM network, the cell reselection criteria may be based on the C1 and C2 criterions. Alternatively, for a UMTS network or a WCDMA network, there may be other cell reselection criteria such as a cell rank criteria. The MS may check for the Location Area Identity (LAI) from the system information message present on the BCCH, the broadcast channel (BCH), or others, after a cell reselection is performed, wherein the LAI represents a unique identity for different Location Area (LA). When the new cell and the old cell belong to different LAs, an LA update may be required.

LA update is a procedure that makes the network aware of the MS location. This is a prerequisite for mobility where the MS movement can be tracked and its position known in the case of incoming MT calls, MT short message services (MT SMS) or others. Generally, the wireless network architecture for any of the GSM/GPRS/EDGE, WCDMA, CDMA 2000, WiMAX, TD-SCDMA, LTE, LTE-A, TD-LTE, or other technologies embraces the challenge of supporting such functions as paging, location updating and connection handover/reselection. The handover/reselection mechanism guarantees that whenever the mobile is moving from one base station area/cell to another, the radio connection is handed over or reselected to the target base station without interruption. The location update procedure, alternatively, enables the network of the supported RAT to keep track of the subscriber camping within the coverage of the network, while a paging message is used to reach the MS to which a call is destined (e.g. MT call, MT SMS or others). Each LA is uniquely identified with a Location Area Identity (LAI) and the LAI consists of a Mobile Country Code (MCC)+Mobile Network Code (MNC)+LA code (LAC).

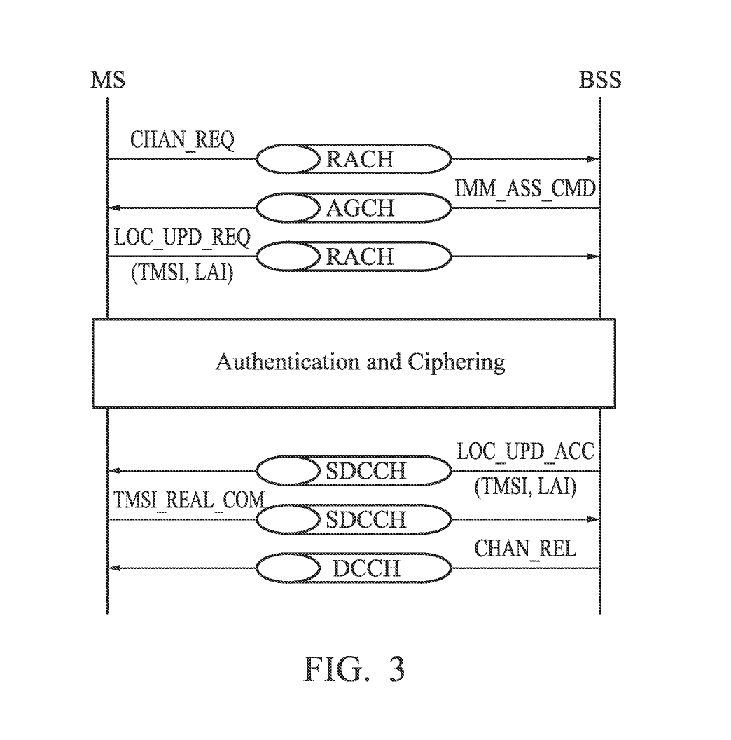

FIG. 3 is a diagram illustrating an exemplary LA update procedure for a GSM network. In a GSM LA update procedure, the MS may firstly request for a channel by sending a Channel Request (CHAN_REQ) message on the RACH, the BSS may respond by sending an Immediate Assignment Command message (IMMASS_CMD) on the AGCH. Then, the MS may switch to the assigned SDCCH and reply to the BSS with a Location Update Request (LOC_UPD_REQ). Included in the LOC_UPD_REQ is the TMSI that the MS is currently using as well as the Location Area Identifier (LAI) of the Visitor Location Register (VLR) it is leaving, and the BTS may acknowledge receipt of the message (not shown) to the BSS. An authentication procedure is then carried out. In the case where the authentication is unsuccessful, the procedure is aborted. In the case where the authentication is successful, the ciphering procedure is performed. The authentication and ciphering procedures are similar to the CC as shown in FIG. 2 and is not repeated here for brevity. Once the MS has been authenticated and is in a Cipher Mode, the MSC/VLR may send a Location Update Accept message (LOC_UPD_ACC) through the BSS to the MS. The LOC_UPD_ACC may have a TMSI assignment in it. The MS may then respond with a TMSI Reallocation Complete message (TMSI_REAL_COM) indicating that it has received the TMSI. The BSS then sends the MS a Channel Release message (CHAN_REL) instructing the MS to go into idle mode. The BSS then un-assigns the SDCCH. As far as the MS is concerned, the location update has been completed. The LA update procedure in WCDMA, TD-SCDMA or UMTS systems is similar to that of the GSM systems and is omitted herein

Mobile-terminated (MT) SMS messages are transported from the Short Message Service Centre (SMSC) to the destination MS. In a GSM system, a completely established MM connection is required for the transport of SMS messages, which again presumes an existing RR connection with the Link Access Protocol on Dm-channel (LAPDm) protection on an SDCCH or Slow Associated Control Channel (SACCH). An SMS transport Protocol Data Unit (PDU) is transmitted with an RP-DATA message between an MSC and MS using the Short Message Relay Protocol (SM-RP). Correct reception is acknowledged with an RP-ACK message from the SMS service center (mobile-originated SMS transfer). In UMTS, WCDMA or TD-SCDMA systems, before reception of MT SMS messages, a paging procedure has to be performed in order to locate the MS.

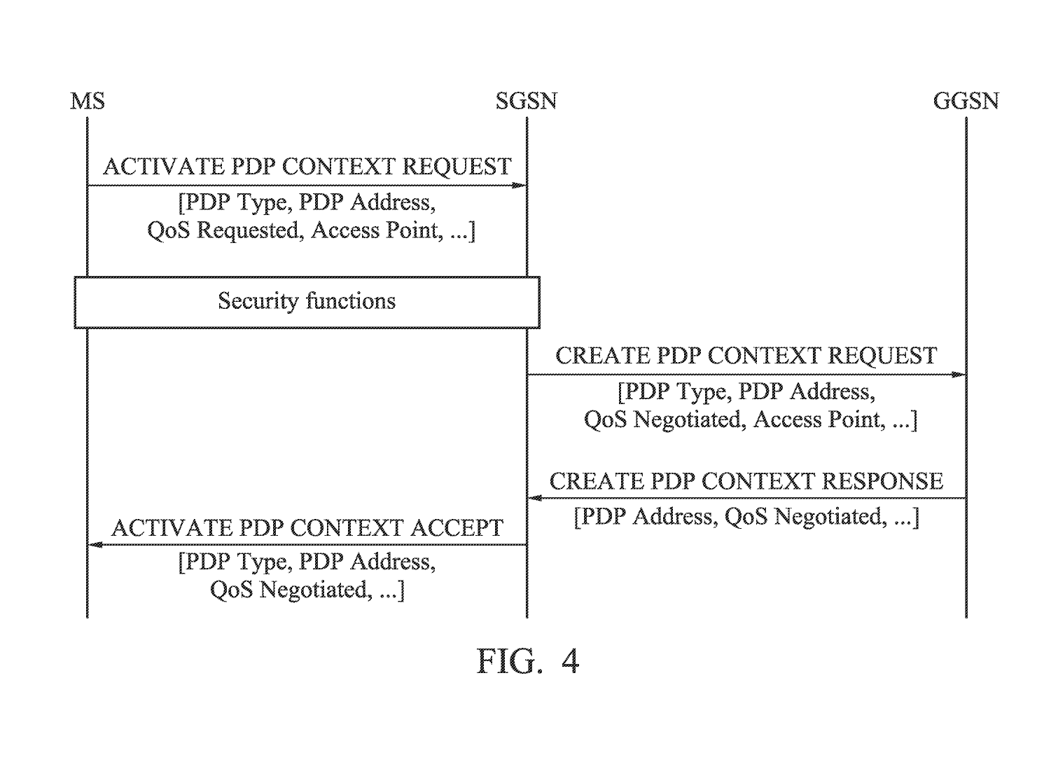

For the GPRS systems, networks based on the Internet Protocol (IP) (e.g. the global Internet or private/corporate intranets) and X.25 networks are supported. Before one of the (U)SIM cards of an MS can use the GPRS service, the MS needs to perform a GPRS attach procedure to attach to the GPRS network with one (U)SIM card. In the GPRS attach procedure, the MS first sends an ATTACH REQUEST message to a Serving GPRS Support Node (SGSN). The GPRS network then checks if the MS is authorized, copies the user profile from the Home Location Register (HLR) to the SGSN, and assigns a Packet Temporary Mobile Subscriber Identity (P-TMSI) to the MS. To exchange data packets with external Public Data Networks (PDNs) after a successful GPRS attach procedure, the MS applies for an address used in the PDN, wherein the address is called a Packet Data Protocol (PDP) address. In the case where the PDN is an IP network, the PDP address is an IP address. For each session, a so-called PDP context is created, which describes the characteristics of the session. The PDP context describes the PDP type (e.g. IPv4, IPv6 or others), the PDP address assigned to the MS, the requested Quality of Service (QoS) class and the address of a Gateway GPRS Support Node (GGSN) that serves as the access point to the external network. FIG. 4 is a diagram illustrating the PDP context activation procedure initialized by an MS. With the ACTIVATE PDP CONTEXT REQUEST message, the MS informs the SGSN of the requested PDP context. After that, the typical GSM security functions (e.g. authentication of the MS) are performed. If the access is granted, the SGSN will send a CREATE PDP CONTEXT REQUEST message to the affected GGSN. The GGSN creates a new entry in its PDP context table, which enables the GGSN to route data packets between the SGSN and the external PDN. The GGSN confirms the request to the SGSN with a CREATE PDP CONTEXT RESPONSE message. Finally, the SGSN updates its PDP context table and confirms the activation of the new PDP context to the MS with an ACTIVATE PDP CONTEXT ACCEPT message. Note that for an MS using both CS and PS services, it is possible to perform a combined GPRS/IMSI attach procedure. The disconnection from the GPRS network is called GPRS detachment, which may be initiated by the MS or by the GPRS network.

In addition, IP packets are transmitted encapsulated within the GPRS backbone network. The transmission is achieved using the GPRS Tunneling Protocol (GTP), that is, GTP packets carry the user's IP packets. The GTP is defined both between GPRS Supports Nodes (GSNs) within the same PLMN and between GSNs of different PLMNs. The GTP contains procedures in the transmission plane as well as in the signaling plane. In the transmission plane, the GTP employs a tunnel mechanism to transfer user data packets. In the signaling plane, the GTP specifies a tunnel control and management protocol. The signaling is used to create, modify, and delete tunnels. A Tunnel Identifier (TID), which is composed of the IMSI of the (U)SIM card and a Network Layer Service Access Point Identifier (NSAPI) uniquely indicates a PDP context. Below the GTP, a transmission control protocol (TCP) is employed to transport the GTP packets within the backbone network. In the network layer, IP is employed to route the packets through the backbone. Taking the GSM systems for example, after the MS successfully attaches to a GPRS network with a (U)SIM card, a cell supporting GPRS may allocate physical channels for GPRS traffic. In other words, the radio resources of a cell in a service network are shared by the MS with the (U)SIM card.

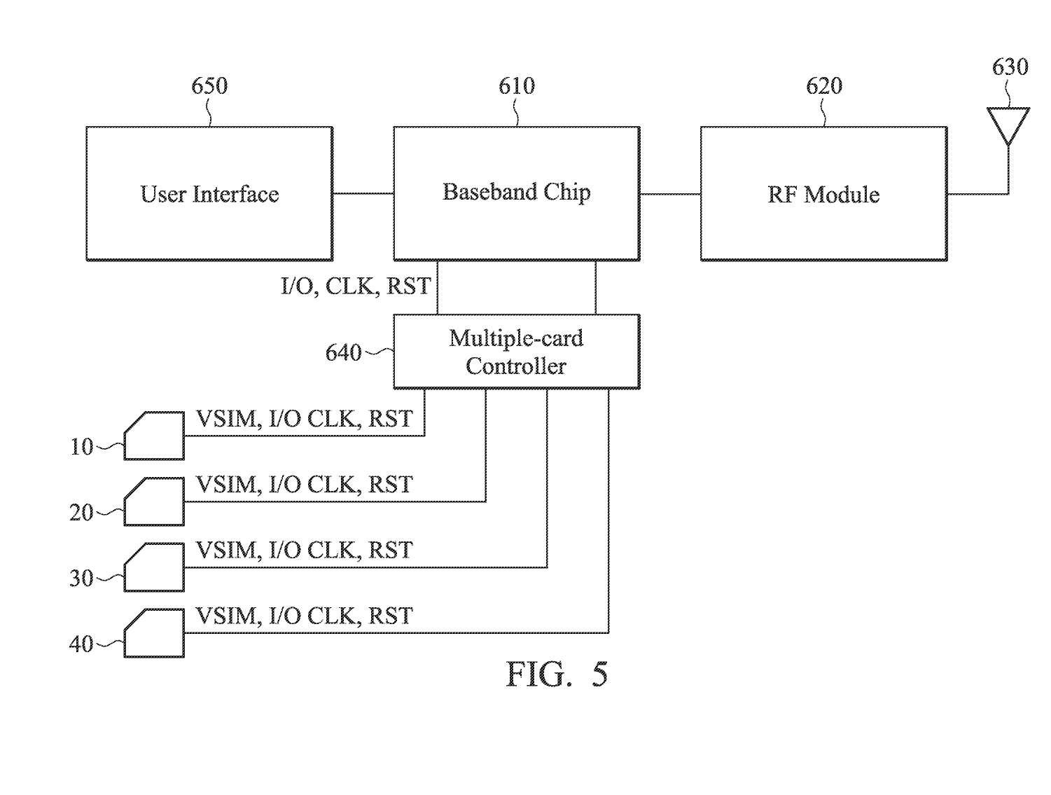

FIG. 5 is a block diagram illustrating the hardware architecture of an MS according to an embodiment of the invention. The MS is equipped with a baseband chip 610, and a single RF module 620 coupled with an antenna 630. The baseband chip 610 may contain multiple hardware devices to perform baseband signal processing, including analog to digital conversion (ADC)/digital to analog conversion (DAC), gain adjusting, modulation/demodulation, encoding/decoding signalings, and so on. The RF module 620 may receive RF wireless signals from the antenna 630, convert the received RF wireless signals to baseband signals, which are then processed by the baseband chip 610, or receive baseband signals from the baseband chip 610 and convert the received baseband signals to RF wireless signals, which are later transmitted via the antenna 630. The RF module 220 may also contain multiple hardware devices to perform radio frequency conversions. For example, the RF module 220 may comprise a mixer to multiply the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in UMTS and WCDMA systems, or others depending on the radio access technology (RAT) in use. As shown in FIG. 5, the subscriber identity cards 10, 20, 30 and 40 are plugged into four sockets of the MS. The MS may further comprise a multiple-card controller 640 coupled or connected between the baseband chip 610 and the subscriber identity cards 10, 20, 30 and 40. The multiple-card controller 640 powers the subscriber identity cards 10, 20, 30 and 40 with the same or different voltage levels according to requirements thereof by a power management integrated chip (PMIC) and a battery, wherein the voltage level for each subscriber identity card is determined during initiation. The baseband chip 610 reads data from one of the subscriber identity cards 10, 20, 30 and 40, and writes data to one of the subscriber identity cards 10, 20, 30 and 40 via the multiple-card controller 640. In addition, the multiple-card controller 640 selectively transfers clock (CLK), reset (RST), and/or input/output data signals (I/O) to the subscriber identity cards 10, 20, 30 and 40 according to instructions issued by the baseband chip 610. The baseband chip 610 may support one or more of the GSM/GPRS/EDGE, UMTS, WCDMA, CDMA 2000, WiMAX, TD-SCDMA, LTE, and TD-LTE technologies. The subscriber identity cards 10, 20, 30 and 40 may be any of the Subscriber Identity Module (SIM) cards, Universal SIM (USIM) cards, Removable User Identity Module (R-UIM), and CDMA Subscriber Identity Module (CSIM) cards, which correspond to the wireless communications technologies supported by the baseband chip 610. In the case where the WiMAX technology is used, the MS may prompt the user for a user name and password through the user interface 650, which may include a keyboard, a touch panel, a touch screen, a joystick, a mouse and/or a scanner, and so on. The MS may therefore simultaneously camp on as many cells provided by either the same network operator or different network operators for the plugged in subscriber identity cards 10, 20, 30 and 40, and operate in different modes such as a connected mode, idle mode, cell Dedicated Channel (CELL_DCH) mode, cell Forward access channel (CELL_FACH) mode, cell Paging Channel (CELL_PCH) mode and UTRAN Registration Area Paging Channel (URA_PCH) mode, by using the single RF module 620 and the baseband chip 610.

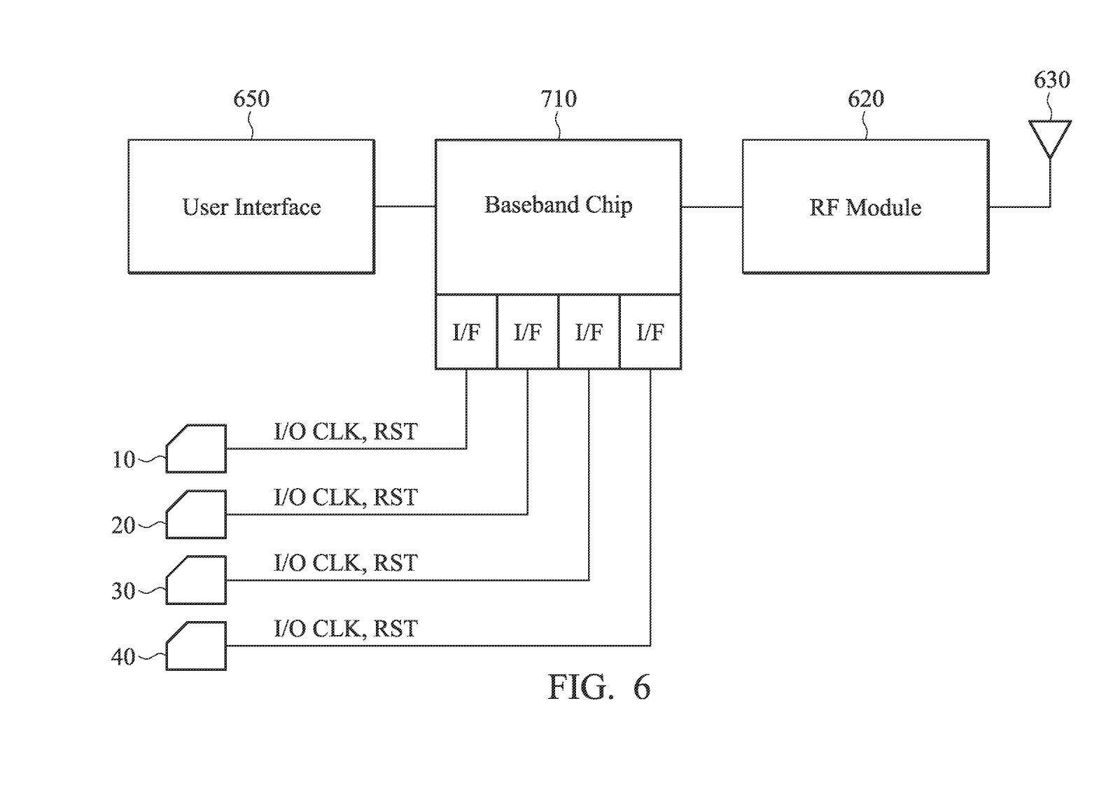

Alternatively, FIG. 6 shows a block diagram illustrating the hardware architecture of an MS according to another embodiment of the invention. Similar to FIG. 6, the baseband chip 710 performs baseband signaling processing, such as analog to ADC/DAC, gain adjusting, modulation/demodulation, encoding/decoding signalings, and so on. However, the connections from the MS to the subscriber identity cards 10, 20, 30 and 40 are independently handled by four interfaces (I/F) provided from the baseband chip 710. In the case where the WiMAX technology is used, the MS may prompt the user for a user name and password through the user interface 650. It is to be understood that the hardware architecture as shown in FIG. 5 or 6 may be modified to include less than four or more than four subscriber identity cards, and the invention is not limited thereto.

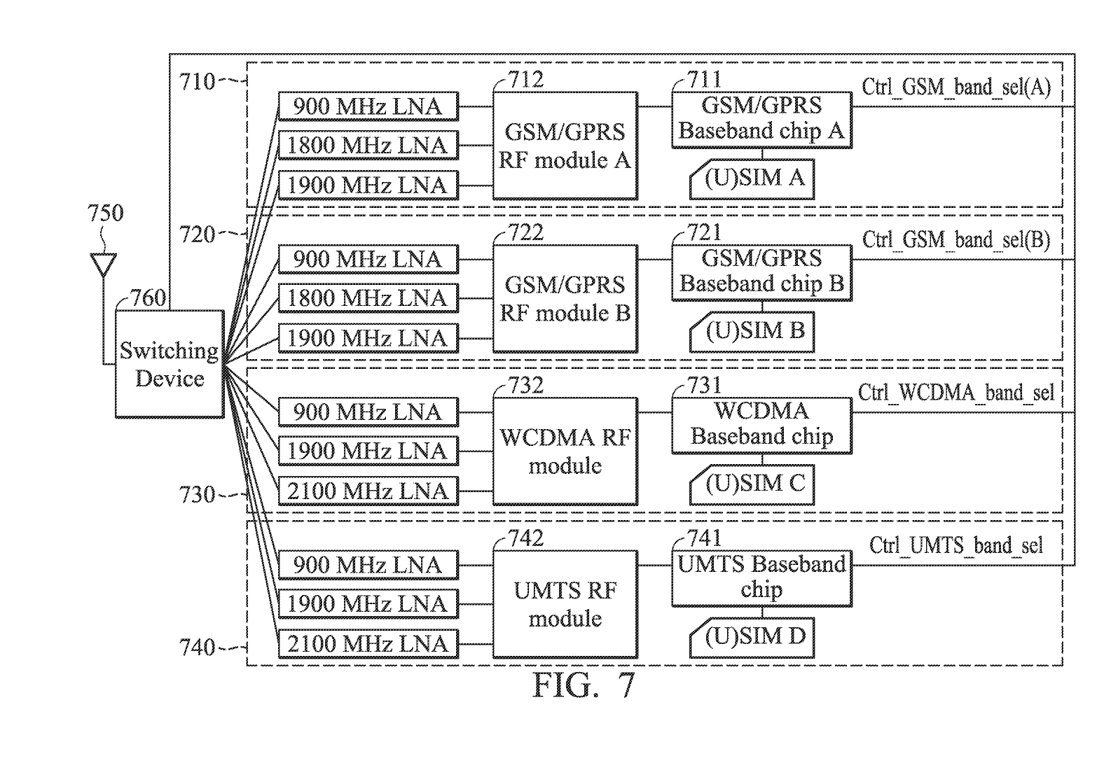

FIG. 7 is a block diagram illustrating the hardware architecture of an MS coupled with four subscriber identity cards and a single antenna according to another embodiment of the invention. The exemplary hardware architecture may be applied to any MS utilizing GSM/GPRS, UMTS and WCDMA technologies. In the exemplary hardware architecture, four Radio Access Technology (RAT) modules, the GSM/GPRS module A 710, the GSM/GPRS module B 720, the WCDMA module B 730 and the UMTS module B 740 may share a single antenna 750, and each RAT module contains at least an RF module and a baseband chip, to camp on a cell and operate in stand-by mode, idle mode, connected mode, CELL_DCH mode, CELL_FACH mode, CELL_PCH mode, URA_PCH mode, and so on. As shown in FIG. 7, the GSM/GPRS baseband chip A 711 is coupled to a GSM/GPRS RF module A 712, the GSM/GPRS baseband chip B 721 is coupled to a GSM/GPRS RF module B 722, the WCDMA baseband chip A 731 is coupled to a WCDMA RF module A 732, and the UMTS baseband chip 741 is coupled to a UMTS RF module 742. In addition, when operating in a specific mode, each RAT module may interact with a specific subscriber identity card as required, such as the (U)SIM A, B, C or D (note: no specific subscriber identity card is required when using a WiMAX network or a WiFi network). A switching device 760 is coupled between the shared antenna 750 and multiple Low Noise Amplifiers (LNAs), and connects the antenna 750 to one LNA to allow the RF signals to pass through the connected LNA. Each LNA amplifies signals in a 2G/3G/4G band received by the shared antenna 750 and provides the signals to corresponding RF modules 712/722/732/742, wherein the 2G/3G/4G band may be a 900 MHz, 1800 MHz, 1900 MHz, or 2100 MHz band, or others. Once one of the baseband chips 711/721/731/741 attempts to perform a transceiving activity, such as a transmission (TX) or a reception (RX) activity, it issues a control signal CtrlGSM_bandsel(A), Ctrl_GSM_band_sel(B), Ctrl_UMTS_band_sel or Ctrl_WCDMA_bandsel to direct the switching device 760 to connect the shared antenna 750 to a designated LNA. Note that the GSM/GPRS baseband chips 711/721, the WCDMA baseband chip 731 and the UMTS baseband chip 741 are further connected to each other for performing the coordination operations relating to the suspension/termination and resumption/restart of data transmission or reception as described previously (not shown). The GSM/GPRS baseband chips 711/721, the WCDMA baseband chip 731 and the UMTS baseband chip 741 may also be connected to a user interface similar to the user interface 650 as described previously for user inputs/outputs. It is to be understood that the GSM/GPRS module A 710, the GSM/GPRS module B 720, the WCDMA module B 730 and the UMTS module B 740 are given as examples. For those skilled in the art, it may be contemplated to use any of the GSM/GPRS/EDGE, WCDMA, CDMA 2000, WiMAX, TD-SCDMA, LTE, LTE-A, TD-LTE, or other technologies, to implement the RAT modules 710, 720, 730 and 740 in the hardware architecture without departing from the spirit of the invention, and the invention is not limited thereto. It is to be understood that the hardware architecture as shown in FIG. 7 may be modified to include less or more subscriber identity cards corresponding to different service networks, and the invention is not limited thereto.

A SIM card typically contains user account information, an international mobile subscriber identity (IMSI), and a set of SIM application toolkit (SAT) commands. In addition, storage space for phone book contacts is provided in SIM cards. A micro-processing unit (MCU) of a baseband chip (referred to as a Baseband MCU hereinafter) may interact with the MCU of a SIM card (referred to as a SIM MCU hereinafter) to fetch data or SAT commands from the plugged SIM card. An MS is immediately programmed after the SIM card is plugged in. SIM cards may also be programmed to display custom menus for personalized services. A SIM card may further store a Home Public-Land-Mobile-Network (HPLMN) code to indicate an associated network operator, wherein the HPLMN code contains a Mobile Country Code (MCC) followed by a Mobile Network code. To further clarify, an IMSI is a unique number associated with a global system for mobile communication (GSM) or a universal mobile telecommunications system (UMTS) network user. An IMSI may be sent by an MS to a GSM or UMTS network to acquire other detailed information of the network user in the Home Location Register (HLR) or to acquire the locally copied detailed information of the network user in the Visitor Location Register (VLR). Typically, an IMSI is 15 digits long or shorter (for example, the MTN South Africa's IMSIs are 14 digits long). The first 3 digits are the Mobile Country Code (MCC), and are followed by the Mobile Network Code (MNC), either 2 digits (European standard) or 3 digits (North American standard). The remaining digits are the mobile subscriber identification numbers (MSIN) for a GSM or UMTS network user.

A USIM card is inserted in an MS for UMTS (also called 3G) telephony communication. A USIM card stores user account information, IMSI information, authentication information and a set of USIM Application Toolkit (USAT) commands therein, and provides storage space for text messages and phone book contacts. A USIM card may further store a Home Public-Land-Mobile-Network (HPLMN) code therein to indicate an associated network operator. A Baseband MCU may interact with an MCU of a USIM card (referred to as a USIM MCU hereinafter) to fetch data or USAT commands from the plugged in USIM card. Note that the phone book on the USIM card has been greatly enhanced from that of the SIM card. For authentication purposes, the USIM card may store a long-term preshared secret key K, which is shared with the Authentication Center (AuC) in the network. The USIM MCU may verify a sequence number that must be within a range using a window mechanism to avoid replay attacks, and is in charge of generating the session keys CK and IK to be used in the confidentiality and integrity algorithms of the KASUMI (also termed A5/3) block cipher in UMTS. An MS is immediately programmed after plugging in the USIM card. In addition, an R-UIM or CSIM card is developed for a CDMA MS that is equivalent to the GSM SIM and 3G USIM, except that it is capable of working in CDMA networks. The R-UIM or CSIM card is physically compatible with the GSM SIM card, and provides a similar security mechanism for CDMA networks and network users.

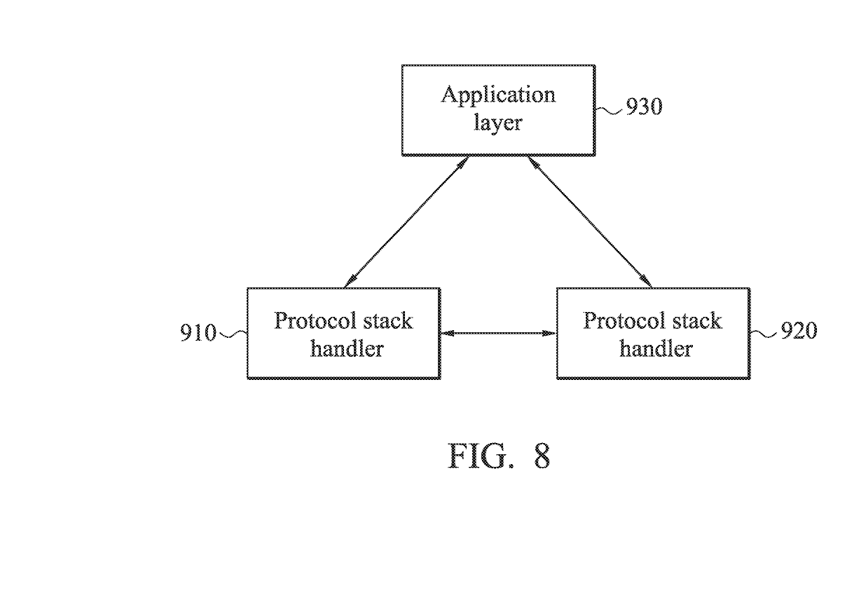

FIG. 8 is a block diagram illustrating the software architecture of an MS according to an embodiment of the invention. The exemplary software architecture may contain the protocol stack handlers 910 and 920, and an application layer 930. The protocol stack handler 910, when executed by a processing unit or a Baseband MCU, is configured to communicate with a first service network (e.g. the service network 120) with a first subscriber identity card (e.g. the subscriber identity card 10), while the protocol stack handler 920, when executed by a processing unit or a Baseband MCU, is configured to communicate with a second service network (e.g. the service network 150) with a second subscriber identity card (e.g. the subscriber identity card 40). Alternatively, the protocol stack handler 910 may be configured to communicate with a first service network (e.g. the service network 140) with a first subscriber identity card (e.g. the subscriber identity card 30), while the protocol stack handler 920 is configured to communicate with a second service network (e.g. the service network 130) with a second subscriber identity card (e.g. the subscriber identity card 20). The application layer 930 may contain program logics for providing Man-Machine Interface (MMI) or the user interface 650 as illustrated in FIG. 5 and FIG. 6. The MMI is the means by which people interact with the MS, and the MMI may contain screen menus and icons, a keyboard, shortcuts, command language, and online help, as well as physical input devices, such as buttons, a touch screen, and a keypad. By the input devices of the MMI, users may manually touch, press, click, or move the input devices to operate the MS for making or answering a phone call, texting, or sending or viewing short messages, multimedia messages, e-mails or instant messages, surfing the Internet, or others. Specifically, the application layer 930 may notify the user of an incoming MT call or MT SMS by showing an “incoming call” or “incoming SMS” message on a display panel of the MS and/or by ringing or vibrating. Correspondingly, the application layer 930 may contain a web browser allowing a user to browse the Internet, a streaming video player allowing a user to watch streaming videos online, an e-mail client allowing a user to edit, browse, or send e-mail messages, and/or a data call agent allowing a user to initiate or receive a data call. When the protocol stack handler 920 is performing a packet-switched (PS) data service on-line, the protocol stack handler 910 may constantly listen to the paging channel for paging messages sent from the first service network. In an embodiment, the protocol stack handler 910 may listen to the paging channel (PCH) for paging messages within an associated Discontinuous Reception (DRX) group or an associated paging group signaled by a higher layer when the associated first service network is a GSM network. In another embodiment, when the associated first service network is a WCDMA or UMTS network, the protocol stack handler 910 may listen to the associated paging indicator (PI) messages which are transmitted in the Paging Indicator Channel (PICH) in the paging occasion at each DRX cycle, and listen to the PCH in an associated Secondary Common Control Physical Channel (S-CCPCH) for paging messages when the PICH carries a PI message intended for the MS. When the protocol stack handler 910 receives a paging message intended for the MS for a CS service such as an MT call, an MT SMS, or others, the protocol stack handler 910 may request the protocol stack handler 920 to suspend the PS data service. In an embodiment, as soon as the PS data service is suspended by the protocol stack handler 920 for the protocol stack handler 910 to start receiving the MT call or the MT SMS with the first subscriber identity card, the protocol stack handler 910 may notify the application layer 930 for the incoming MT call or MT SMS, and the application layer 930 would signal the user by showing an “incoming call” or “incoming SMS” message on the display device of the MS and/or by ringing or vibrating. Later, when the MT call is finished or the MT SMS is received, the application layer 930 may receive a signal from the user which is triggered by the user hanging up the phone (e.g. by pressing or clicking on an end key or selecting end call from a touch panel input, or by a signal from the first service network indicating call finish), wherein the application layer 930 may inform the protocol stack handler 910 upon finishing the CS service. Then, the protocol stack handler 910 informs the protocol stack handler 920 to resume or restart the PS data service. In one embodiment, when the MT call is finished or reception of the MT SMS is completed, the protocol stack handler 910 checks whether the PS data service has been suspended due to the CS service (an MT call, an MT SMS, or other CS services). If so, the protocol stack handler 910 then informs the protocol stack handler 920 to resume or restart the PS data service. For example, the protocol stack handler 910 may use a flag or marker to note the aforementioned condition, e.g. the default value of the flag or marker may be set to “OFF”, the value of the flag or marker may be set to “ON” when the PS data service is suspended for a CS service, and the value of the flag or marker may be set to “OFF” when the CS service is finished.

In another embodiment, the protocol stack handler 910 may be configured to perform power measurements while the protocol stack handler 920 performs a PS data service. When the protocol stack handler 920 is performing a PS data service, there may be time intervals for which the protocol stack handler 920 may not be transferring any PS data at all. For example: when a user uses the PS data service to browse the web, the user may require some time to read the content of the web page after the protocol stack handler 920 has downloaded the content of the web page. While the user is reading, there are no data transfer requests for the protocol stack handler 920. The protocol stack handler 910 may perform background power measurements and cell reselections when the protocol stack handler 920 does not have any PS data activity with the associated second service network. The PS data throughput associated with the protocol stack handler 920 is not affected or downgraded due to the background power measurements. From the power measurement results, the protocol stack handler 910 may make cell reselection decisions depending on different cell reselection criteria corresponding to each radio access technology (RAT). When the protocol stack handler 910 makes a cell reselection according to an associated cell reselection criteria and the protocol stack handler 910 detects an LA change (e.g. the MS reselects to a cell with a different LAI), the protocol stack handler 910 may request the protocol stack handler 920 to suspend the PS data service to perform an LA update. Later, when the LA update is completed, the protocol stack handler 910 may inform the protocol stack handler 920 to resume or restart the PS data service.

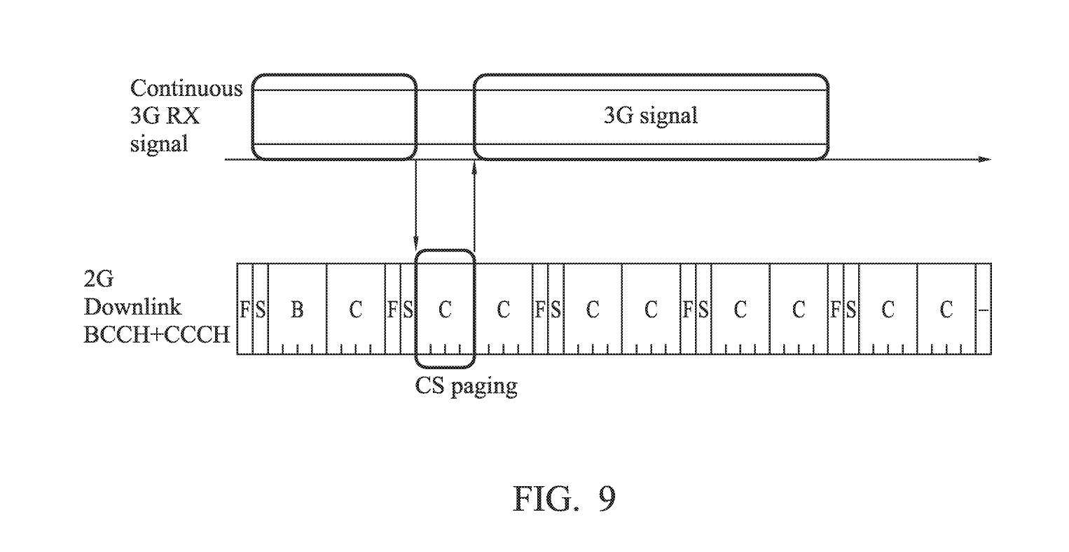

FIG. 9 is a diagram illustrating channel occupancy time for an MS that monitors a 2G CS paging channel in a 3G packet transfer mode according to an embodiment of the invention. Assume the protocol stack handler 920 is performing a packet-switched (PS) data service (e.g. e-mail, web browsing and so on) on-line with a second service network (e.g. a UMTS service network 150) with a second subscriber identity card (e.g. the subscriber identity card 40), and the protocol stack handler 910 is configured to communicate with a first service network (e.g. the 2G GSM/GPRS/EDGE service network 130) with a first subscriber identity card (e.g. the subscriber identity card 20). The protocol stack handler 910 may constantly listen to the 2G paging channel in a common control channel (CCCH) for paging messages sent from the first service network. The protocol stack handler 910 may synchronize itself with the paging cycle associated with the first service network, calculate paging occasions of the paging channel, and wake up at the right moment in time to listen to its allocated paging channel (e.g. by taking control of the single radio resource hardware such as a single antenna or single RF module over the protocol stack handler 920). If no paging messages intended for the MS are received, the protocol stack handler 910 returns the control of the radio resource hardware back to the protocol stack handler 920, and the protocol stack handler 920 may continue with the PS data service. While the protocol stack handler 910 listens to the 2G paging channel, the 3G signal received by the protocol stack handler 920 may experience a momentary discontinuous data reception, and the protocol stack handler 920 may recover the lost data packets by requesting for retransmission or by other data recovery methods. It is assumed that those skilled in the art are knowledgeable about data retransmission techniques, and thus, detailed examples are not provided further.

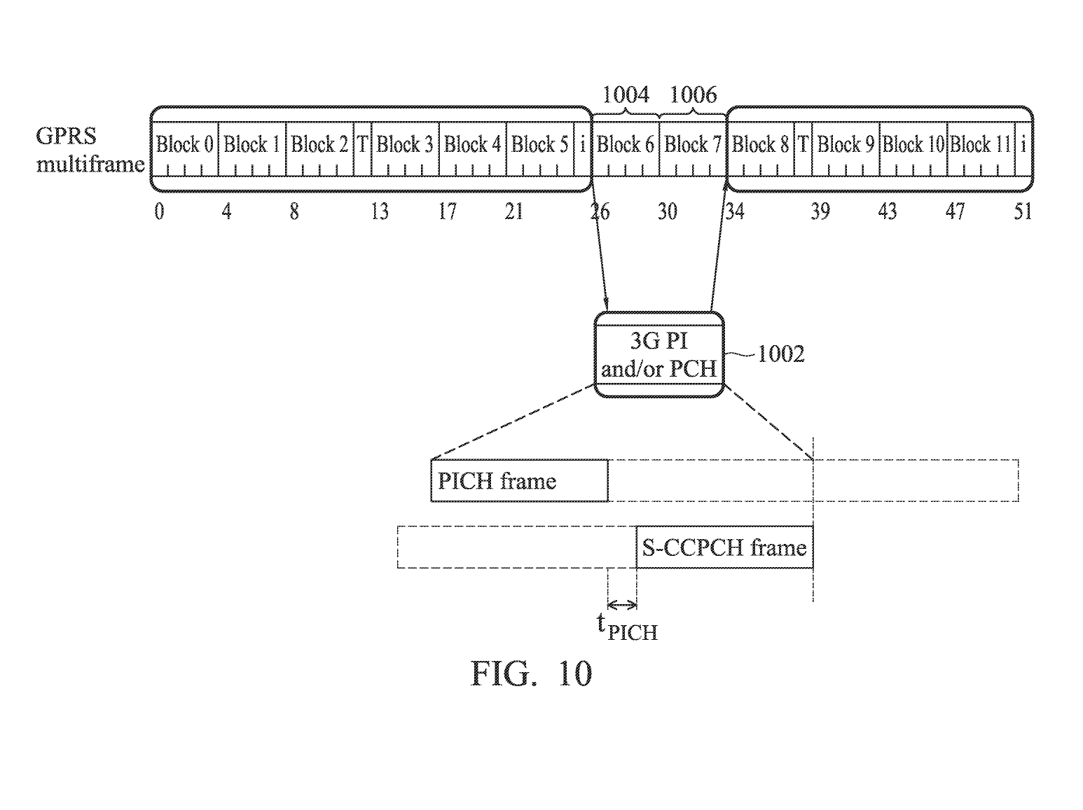

FIG. 10 is a diagram illustrating channel occupancy time for an MS that monitors a 3G CS paging channel in a 2G packet transfer mode according to an embodiment of the invention. Assuming the protocol stack handler 920 is performing a packet-switched (PS) data service (e.g. e-mail, web browsing and so on) on-line with the second service network (e.g. a 2G GSM/GPRS/EDGE network 120) with a second subscriber identity card (e.g. the subscriber identity card 10), and the protocol stack handler 910 is configured to communicate with the first service network (e.g. a WCDMA network 140) with a first subscriber identity card (e.g. the subscriber identity card 30), the protocol stack handler 910 may constantly listen to the 3G paging channel for paging messages sent from the first service network. The protocol stack handler 910 may wake up and listen to the associated paging indicators (PI) which are transmitted in the Paging Indicator Channel (PICH) in the paging occasion at each DRX cycle, and listen to the associated S-CCPCH for paging messages if the PICH carries a PI message intended for the MS (e.g. by taking control of the single radio resource hardware such as a single antenna or single RF module over the protocol stack handler 920). The PICH is a fixed rate (SF=256) physical channel used to carry the PI, wherein the PICH is always associated with an S-CCPCH to which a paging channel (PCH) transport channel is mapped, and a PI set in a PICH frame means that the paging message is transmitted on the PCH in the S-CCPCH frame starting t_{PICH} chips (t_{PICH}=7680 chips or 3 slots) after the PICH frame is transmitted. The protocol stack handler 910 may synchronize with the paging cycle of the network, calculate the paging occasions of the PICH, and wake up at the right moment in time to listen to its allocated PICH (e.g. by taking control of the radio resource hardware over the protocol stack handler 920), and the protocol stack handler 910 may wait and listen to the associated S-CCPCH (the associated S-CCPCH arrives t_{PICH} after the PICH) for paging messages if the PICH carries a PI message intended for the MS. After receiving a paging message on the PCH in the S-CCPCH frame, the protocol stack handler 910 may request the protocol stack handler 920 to suspend the PS data service for the protocol stack handler 910 to receive the MT call or the SMS-MT with the second subscriber identity card. If the PICH does not carry a PI message intended for the MS, the protocol stack handler 910 may return control of the radio resource hardware back to the protocol stack handler 920 and the protocol stack handler 920 may continue with the PS transfer. In FIG. 10, the time position of the 3G PI and/or PCH 1002 starts a moment after the GPRS Block 1004 starts and the 3G PI and/or PCH 1002 ends a moment before the GPRS Block 1006 ends. In an embodiment, the protocol stack handler 910 may “punch a hole” in the GPRS Block 1004 and the GPRS Block 1006, and the protocol stack handler 920 may discard any data that may have been transferred at the very beginning of the GPRS Block 1004 and the very end of the GPRS Block 1006. In another embodiment, the protocol stack handler 920 may be aware of the timing for the 3G PI and/or PCH 1002 (e.g. from the paging occasions information informed by the protocol stack handler 910), and the protocol stack handler 920 may stop the data transfer before the GPRS Block 1004 begins and start the data transfer after the GPRS Block 1006 ends (i.e. the protocol stack handler 920 does not perform data transfer for the entire duration of the GPRS Block 1004 and the GPRS Block 1006).

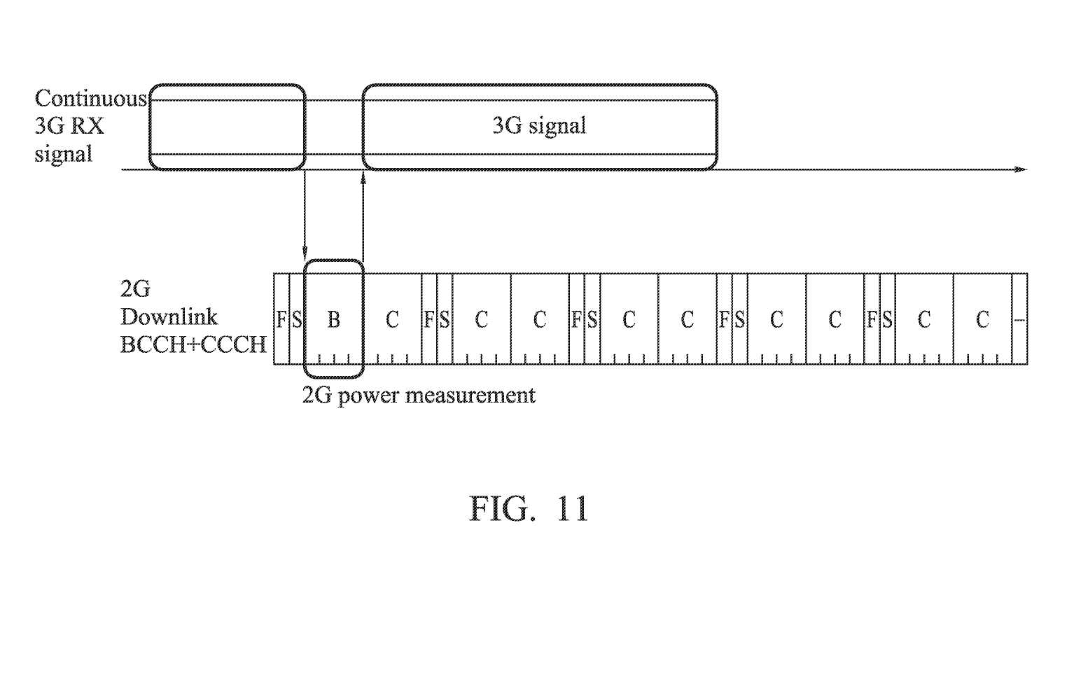

FIG. 11 is a diagram illustrating channel occupancy time for a UE that makes 2G power measurements in a 3G packet transfer mode according to an embodiment of the invention. Assume the protocol stack handler 920 is performing a packet-switched (PS) data service on-line with the second service network (e.g. the UMTS service network 150) with a second subscriber identity card (e.g. the subscriber identity card 40), and the protocol stack handler 910 is configured to communicate with the first service network (e.g. the 2G GSM/GPRS/EDGE network 130) with a first subscriber identity card (e.g. the subscriber identity card 20). When the protocol stack handler 920 is not transmitting or receiving data (e.g. the user is reading a downloaded email and has no data activity) the protocol stack handler 910 may take control of the radio resource hardware to make 2G power measurements (e.g. RSSI of BCCH for surrounding candidate cells). The 2G power measurements made by the protocol stack handler 910 does not affect the 3G data throughput since the 2G power measurements are performed when the protocol stack handler 920 does not have any data activity. The protocol stack handler 920 may give control of the single radio resource hardware, such as a single antenna or single RF module, to the protocol stack handler 910 when there is no PS data activity associated with the second subscriber identity card, and the protocol stack handler 910 may make a round of power measurements to surrounding candidate cells before handing back the control of the single radio resource hardware to the protocol stack handler 920. In another embodiment, The protocol stack handler 920 may give control of the single radio resource hardware to the protocol stack handler 910 when there is no PS data activity with the second service network, and the protocol stack handler 910 may possess control of the single radio resource hardware for a predetermined period of time (e.g. 10 ms, 20 ms and so on), and make power measurements to candidate cells during the predetermined period of time. The protocol stack handler 910 hands back the control of the single radio resource hardware to the protocol stack handler 920 as soon as the predetermined period of time is reached, wherein the protocol stack handler 920 may delay or not delay the scheduled channel tasks associated with the PS data transfer for the predetermined period of time. When the protocol stack handler 910 makes a 2G power measurement and performs a cell reselection with a different LAI (an LA change), the protocol stack handler 910 may request to control the radio resource hardware for performing a 2G LA update with the first service network.

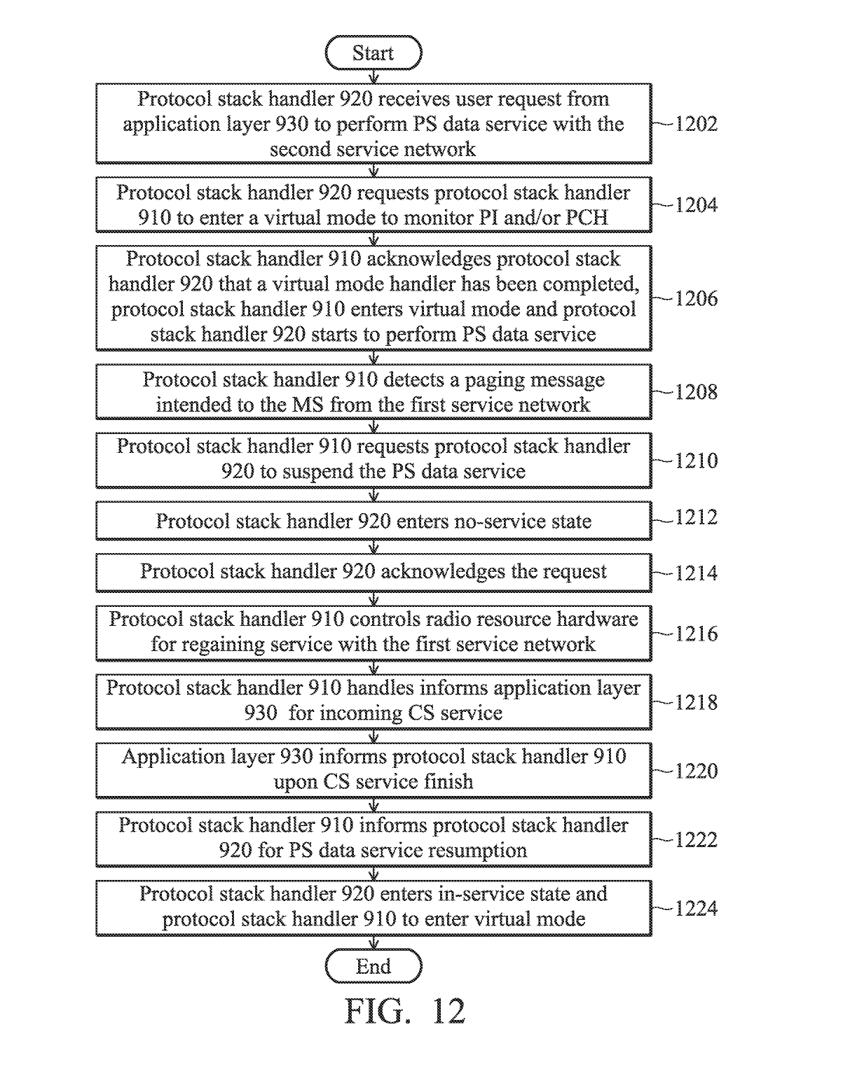

FIG. 12 is a flow chart illustrating a method for coordinating the operations between the protocol stack handlers 910 and 920 using the software architecture of FIG. 8 according to an embodiment of the invention. Initially, the protocol stack handlers 910 and 920 are in the idle mode, and the protocol stack handler 920 receives a user request from the application layer 930 to perform a PS data service such as push e-mail, IM, or others, with the second service network (step 1202). Next, the protocol stack handler 920 requests the protocol stack handler 910 to enter a virtual mode (step 1204). In the virtual mode, the protocol stack handler 910 wakes up at the right moment according to the paging occasions of the camped cell in the first service network and listens to its allocated PCH (in CCCH or in S-CCPCH) for paging messages and/or PICH for PIs. By entering the virtual mode, a portion of data transceiving from/to the second service network is sacrifised to monitor the PCH and/or PICH so as to receive message from the first service network. In the virtual mode, the protocol stack handler 910 may listen to the allocated PCH for paging messages and/or PICH for PIs (e.g. as illustrated in FIG. 9 and FIG. 10) by taking control of the single radio resource hardware, such as particular circuits of the baseband chip to control the single RF module and/or the single antenna. The protocol stack handler 920 may be aware of the timing and the duration of the paging occasions for the PCH and/or the PICH for the protocol stack handler 910 (e.g. informed by the protocol stack handler 910 when the virtual mode handler has been completed), and the protocol stack handler 920 directly pauses the PS data transfer at each paging occasion for the PCH and/or the PICH. When the protocol stack handler 920 pauses the PS data transfer at each paging occasion, the protocol stack handler 920 may simply let the protocol stack handler 910 take control of the radio resource hardware, such as particular circuits of the baseband chip to control the RF module and the antenna, and delay all scheduled channel tasks associated with the PS data transfer for the second service network, such as listening to the PPCH, PCH or others, until the expected paging occasion associated with the protocol stack handler 910 is finished. The protocol stack handler 910 hands back control of the radio resource hardware to the protocol stack handler 920 if no PI or paging messages intended for the MS is received after the current paging occasion is finished and thereafter, waits for the next paging occasion. While the protocol stack handler 910 listens to the allocated PCH for paging messages and/or PICH for PIs, the protocol stack handler 920 may experience a momentary discontinuous data reception, and the protocol stack handler 920 may recover the lost data packets by requesting for retransmission or by other data recovery methods.

After the virtual mode handler has been completed, the protocol stack handler 910 informs the protocol stack handler 920 by sending an acknowledgement for virtual mode handler complete. The protocol stack handler 910 immediately enters the virtual mode after sending the acknowledgement, and the protocol stack handler 920 starts to perform the PS data service of push e-mail or other services upon receiving the acknowledgement (step 1206). While the protocol stack handler 920 is performing the PS data service, the protocol stack handler 910 in the virtual mode detects a paging message in a PCH intended for the MS from the first service network (step 1208). The protocol stack handler 910 requests the protocol stack handler 920 to suspend the PS data service corresponding to the second subscriber identity card in response to the received paging message (step 1210). In one embodiment, when receiving the user request, the protocol stack handler 920 may first determine whether the CS service (e.g. an MT call or an SMS-MT) has higher priority than a PS data service. For example, the CS service may be always specified to have a higher priority than the PS data service, or vise versa. In another example, a service network mainly used for CS services may have a higher priority than another service network mainly used for the PS data services, or users may set one preferred service network with a higher priority among a plurality of service network, wherein the setting may be stored in the subscriber identity cards, a memory device associated with the MS or others. When the CS service has a higher priority than a PS data service, the protocol stack handler 920 suspends the PS data service and then enters the no-service state (Step 1212). Upon entering the no-service state, the protocol stack handler 920 further acknowledges the request from the protocol stack handler 910 (Step 1214). Note that the protocol stack handler 920 may further inform the second service network that the PS data service is being suspended, before suspending the PS data service.

To suspend the PS data service and/or to enter the no-service state, the protocol stack handler 920 may remove scheduled channel tasks, such as listening to the PPCH, PCH or others, causing the MS to receive no packet paging messages from the camped on cell, and hinder any PRACH, RACH, PACCH, or similar uplink channel allocation for the second subscriber identity card (which is associated with the second service network). Alternatively, the protocol stack handler 920 may request the radio resource hardware, such as particular circuits of the baseband chip to control the RF module and the antenna, to suspend the scheduled channel tasks, or for detaching the attached data service, such as a GPRS detach procedure. It is to be understood that, when the radio resource is occupied by the PS data service for the second subscriber identity card, the protocol stack handler 910 no longer transceives data with the first service network except for during the paging occasions associated with the first service network. Thus, after receiving the acknowledgement from the protocol stack handler 920, the protocol stack handler 910 requests the radio resource hardware for regaining of service with the first service network (step 1216).

Subsequent to step 1216, the protocol stack handler 910 informs the application layer 930 of the incoming CS services such as an MT call as shown in FIG. 2, an SMS-MT, or others, corresponding to the first subscriber identity card (Step 1218). The application layer 930 may signal the user of the incoming CS service by displaying “incoming call” or “incoming SMS” on a screen, a display panel, or others of the MS, and rings or vibrates. When the CS service is finished, the application layer 930 may receive an “end call” signal from the user via a keyboard, touch screen, or other input interface. Upon receiving the user signal indicating that the CS service is finished, the application layer 930 informs the protocol stack handler 910 (step 1220). Alternatively, the protocol stack handler 910 may receive a signal from the first service network indicating that the calling party has ended the call or transmission of the SMS-MT is finished. After the CS service is finished, the protocol stack handler 910 requests the protocol stack handler 920 to resume or restart the suspended PS data service (step 1222). Then, the protocol stack handler 920 enters an in-service state to resume or restart the suspended PS data service and the protocol stack handler 910 re-enters the virtual mode to listen to its allocated PCH for paging messages and/or PICH for PIs (step 1224). To resume the PS data service or to enter the in-service state, the protocol stack handler 920 may re-schedule channel tasks, such as listening to the PPCH, PCH or others, causing the MS to receive packet paging messages and allow PRACH, RACH, PACCH, or similar channel allocation procedures to be performed. Alternatively, the protocol stack handler 920 may request the radio resource hardware for resuming of the scheduled channel tasks, or for attaching data services, such as the GPRS PDP context activation as shown in FIG. 4. It is to be understood that the suspended PS data service may be resumed without any information loss when the suspending time period is shorter than a tolerable time, or, during the suspending time period, no data is required to be received by the corresponding application, such as that from an e-mail client, IM client, or others. In the embodiment illustrated in FIG. 12, the basebandchip of the MS is configured to perform the packet-switched (PS) data service associated with the second service network while sacrificing a portion of data transceiving from/to the second service network to monitor the channel (e.g. the PICH and/or the PCH) associated with the first service network during the PS data service, so as to receive message from the first service network.

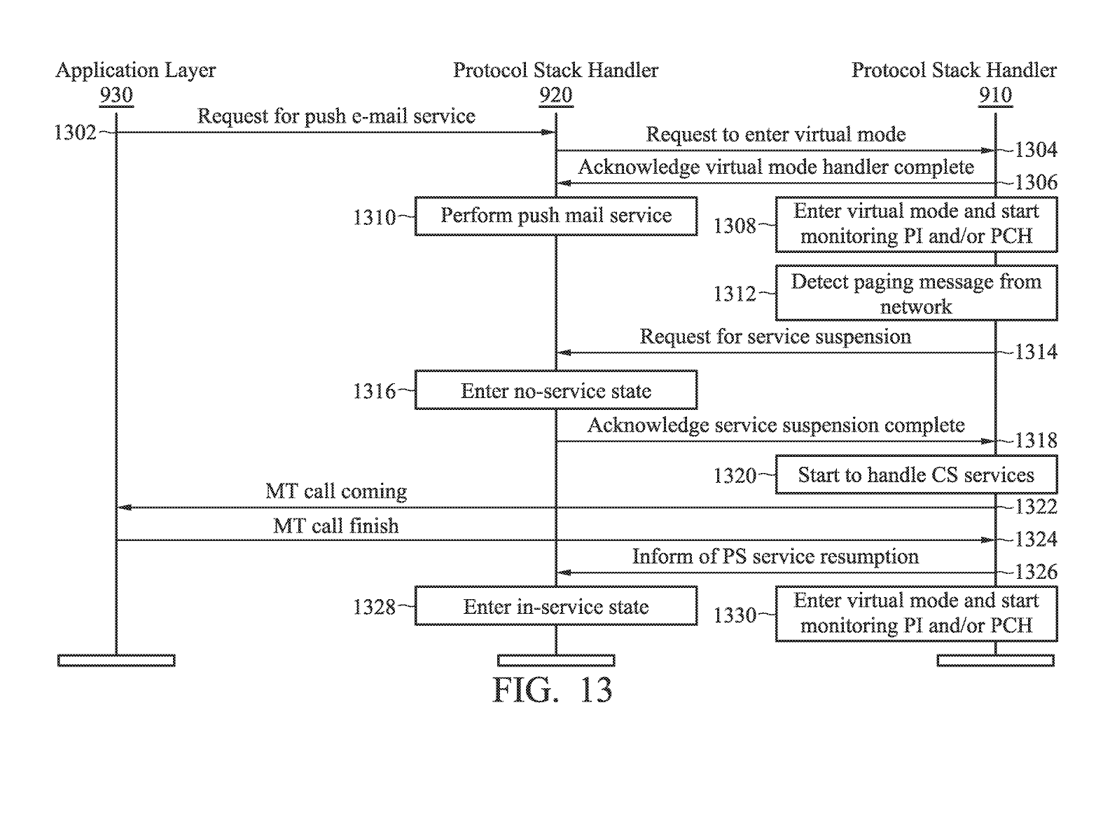

FIG. 13 is a message sequence chart illustrating the method for coordinating the operations between the protocol stack handlers 910 and 920 according to the embodiment of FIG. 12. Initially, the protocol stack handlers 910 and 920 are in the idle mode, and the protocol stack handler 920 receives a user request from the application layer 930 to perform a push e-mail service (step 1302). Alternatively, the protocol stack handler 920 may also receive the user request from the application layer 930 to perform other PS data services such as IM, web browsing, location services, or others. Upon receiving the PS data service request from the application layer 930, the protocol stack handler 920 requests the protocol stack handler 910 to enter a virtual mode to listen to the corresponding PCH (in a CCCH or in a S-CCPCH) for paging messages and/or PICH for PIs (step 1304). In the virtual mode, the protocol stack handler 910 may listen to the allocated PCH for paging messages and/or PICH for PIs (e.g. as illustrated in FIG. 9 and FIG. 10) by taking control of the single radio resource hardware, such as particular circuits of the baseband chip to control the single RF module and/or the single antenna. By entering the virtual mode, a portion of data transceiving from/to the second service network is sacrificed to monitor the PCH and/or PICH so as to receive message from the first service network. The protocol stack handler 920 may be aware of the timing and the duration of the paging occasions for the PCH and/or the PICH for the protocol stack handler 910 (e.g. informed by the protocol stack handler 910 when the virtual mode handler has been completed), and the protocol stack handler 920 may pause the PS data transfer at each paging occasion for the PCH and/or the PICH. When the protocol stack handler 920 pauses the PS data transfer at each paging occasion, the protocol stack handler 920 may simply let the protocol stack handler 910 take control of the radio resource hardware, such as particular circuits of the baseband chip to control the RF module and the antenna, and delay all scheduled channel tasks associated with the PS data transfer for the second service network, such as listening to the PPCH, PCH or others, until the expected paging occasion associated with the protocol stack handler 910 is finished. After the protocol stack handler 910 has completed the virtual mode handler, the protocol stack handler 910 informs the protocol stack handler 920 by sending an acknowledgement for virtual mode handler complete (step 1306), wherein the acknowledgement may contain information about timing information for paging occasions associated with the protocol stack handler 910. The protocol stack handler 910 immediately enters the virtual mode to listen to the corresponding PCH for paging messages and/or PICH for PIs after sending the acknowledgement (step 1308). Alternatively, upon receiving the acknowledgement for completion of the virtual mode handler, the protocol stack handler 920 starts to perform the PS data service of push e-mail or other services (step 1310).

Meanwhile, the protocol stack handler 910 in the virtual mode detects a paging message from the PCH intended to the MS from the associated service network (step 1312). The protocol stack handler 910 requests the protocol stack handler 920 to suspend the push e-mail service corresponding to the second subscriber identity card in response to the received paging message (step 1314). The protocol stack handler 920 may first determine whether a CS service of an MT call, an SMS-MT, or others, has higher priority than a PS data service by checking a preset user preference. When the CS service has higher priority than a PS data service, the protocol stack handler 920 suspends the PS data service and then enters the no-service state (Step 1316). Upon entering the no-service state, the protocol stack handler 920 further acknowledges the request from the protocol stack handler 910 (Step 1318). To suspend the PS data service and/or to enter the no-service state, the protocol stack handler 920 may remove scheduled channel tasks, such as listening to the PPCH, PCH or others, causing the MS to receive no packet paging messages from the camped on cell, and hinder any PRACH, RACH, PACCH, or similar uplink channel allocation for the second subscriber identity card (which is associated with the second service network). Alternatively, the protocol stack handler 920 may request the radio resource hardware, such as particular circuits of the baseband chip to control the RF module and the antenna, to suspend the scheduled channel tasks, or for detaching the attached data service, such as a GPRS detach procedure. After receiving the acknowledgement from the protocol stack handler 920, the protocol stack handler 910 requests the radio resource hardware to regain service with the first service network and start to handle the CS service associated with the received paging message (step 1320).

Subsequent to step 1320, the protocol stack handler 910 informs the application layer 930 of the incoming CS services such as an MT call as shown in FIG. 2, an SMS-MT, or others, with the first service network (Step 1322). The application layer 930 may signal the user of the incoming CS service by displaying “incoming call” or “incoming SMS” on a screen, a monitor, or others of the MS, and rings or vibrates. When the CS service is finished, the application layer 930 may receive an “end call” signal from the user via a keyboard, touch screen, or other input interface. Upon receiving the user signal indicating that the CS service is finished, the application layer 930 informs the protocol stack handler 910 (step 1324). Alternatively, the protocol stack handler 910 may receive a signal from the first service network indicating that the calling party has ended the call or transmission of the SMS-MT is finished. The protocol stack handler 910 then requests the protocol stack handler 920 to resume or restart the suspended PS data service (step 1326). Then, the protocol stack handler 920 enters an in-service state to resume or restart the suspended PS data service (step 1328) and the protocol stack handler 910 re-enters the virtual mode to listen to its allocated PCH for paging messages and/or PICH for PIs (step 1330). To resume the PS data service or to enter the in-service state, the protocol stack handler 920 may re-schedule channel tasks, such as listening to the PPCH, PCH or others, causing the MS to receive packet paging messages and allow PRACH, RACH, PACCH, or similar channel allocation procedures to be performed. Alternatively, the protocol stack handler 920 may request the radio resource hardware for the scheduled channel tasks, or for attaching data services, such as the GPRS PDP context activation as shown in FIG. 4.

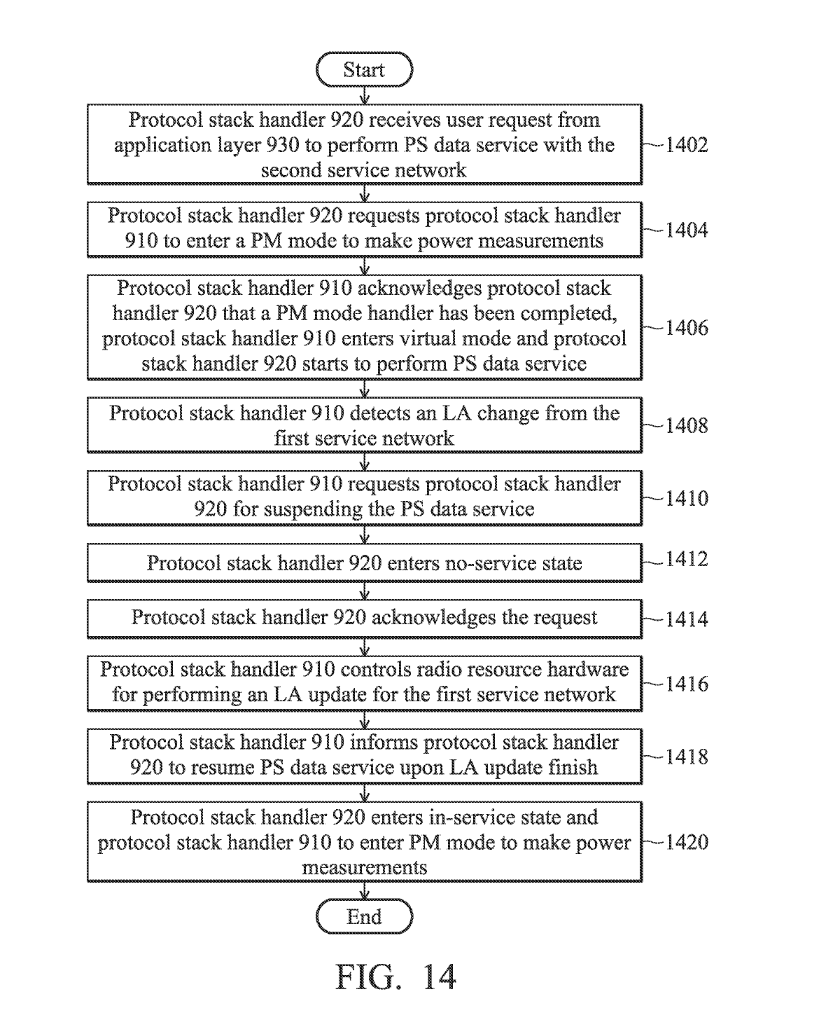

FIG. 14 is a flow chart illustrating the method for coordinating the operations between the protocol stack handlers 910 and 920 using the software architecture of FIG. 9 according to another embodiment of the invention. Similar to the step 1202 in FIG. 12, the protocol stack handlers 910 and 920 are in the idle mode, and the protocol stack handler 920 receives a user request from the application layer 930 to perform a PS data service with the second service network. Next, the protocol stack handler 920 requests the protocol stack handler 910 to enter a power measurement (PM) mode (step 1404). In the PM mode, the protocol stack handler 910 stands by and waits for the protocol stack handler 920 to inform for the appropriate timing to make power measurements (e.g. as illustrated in FIG. 11). Moreover, a portion of data transceiving from/to the second service network is sacrifised to monitor the BCCH and/or CPICH so as to maintain mobility in the first service network. Specifically, when the protocol stack handler 920 is performing a PS data service, there may be time intervals for which the protocol stack handler 920 is not transferring any PS data at all. For example: when a user reads information in a downloaded email or waits for another party to respond thereto when using the IM. The protocol stack handler 920 may give control of the single radio resource hardware, such as a single antenna or single RF module, to the protocol stack handler 910 when there is no PS data activity corresponding to the second subscriber identity card, and the protocol stack handler 910 may make a round of power measurements to surrounding candidate cells before handing back the control of the single radio resource hardware to the protocol stack handler 920. In another embodiment, The protocol stack handler 920 may give control of the single radio resource hardware to the protocol stack handler 910 when there is no PS data activity with the second service network, and the protocol stack handler 910 may possess control of the single radio resource hardware for a predetermined period of time (e.g. 10 ms, 20 ms and so on), and make power measurements to candidate cells during the predetermined period of time. The protocol stack handler 910 hands back the control of the single radio resource hardware to the protocol stack handler 920 as soon as the predetermined period of time is reached, wherein the protocol stack handler 920 may delay or not delay the scheduled channel tasks associated with the PS data transfer for the predetermined period of time. Specifically, when the first subscriber identity card corresponds to a GSM network, the protocol stack handler 910 makes power measurements to the BCCH (e.g. RSSI and so on) of candidate cells in a PM mode. Alternatively, in a UMTS/WCDMA network, the protocol stack handler 910 makes power measurements to the CPICH (e.g. Ec/No, RSCP and so on) of candidate cells in a PM mode. When the first subscriber identity card corresponds to an LTE, LTE-A or WiMAX network, the protocol stack handler 910 may make power measurements of different pilot signals according to different RATs in the PM mode. The protocol stack handler 910 performs power measurements of candidate cells and uses the power measurement results such as measured signal quality and/or signal strength of the BCCH, CPICH, or others as an input for handover and/or cell reselection decisions. From the power measurement results, the protocol stack handler 910 may make cell reselection decisions depending on different cell reselection criteria corresponding to each radio access technology (RAT). For example, for a GSM network, the cell reselection criteria may be based on the C1 and C2 criterions. For a UMTS network or a WCDMA network, there may be other cell reselection criteria such as a cell rank criteria.

After the PM mode handler is completed, the protocol stack handler 910 informs the protocol stack handler 920 by sending an acknowledgement for completion of the PM mode handler. The protocol stack handler 910 immediately enters the virtual mode after sending the acknowledgement, and the protocol stack handler 920 starts to perform the PS data service of push e-mail or other services upon receiving the grant for the PS data service (step 1406). While the protocol stack handler 920 performs PS data services, the protocol stack handler 910 performs a cell reselection procedure according to the power measurements made in the PM mode, and detects that the newly camped cell has a new LAI (an LA change) (step 1408). Specifically, the LAI information is broadcasted in the system information in the BCCH for a GSM network and in the Primary Common Control Physical Channel (P-CCPCH) for a WCDMA or a UMTS network, and the protocol stack handler 910 retrieves the LAI information corresponding to the currently camped on cell after each cell reselection, during the PM mode window. When there is an LA change accompanying with a cell reselection procedure, the protocol stack handler 910 is required to perform a CS service of an LA update in order for the first service network to be aware of the MS's position. The protocol stack handler 910 requests the protocol stack handler 920 to suspend a current PS data service and enter into the no-service state (step 1410 and step 1412). Reference for detailed descriptions regarding the operations in the no-service state may be made to the aforementioned descriptions relating to FIG. 12. After entering the no-service state, the protocol stack handler 920 informs the protocol stack handler 910 that the radio resource has been released by acknowledging the request (step 1414). Then, the protocol stack handler 910 requests the radio resource hardware to regain service for the first service network (step 1416), and handles control signaling and data transceiving until the LA update is finished (e.g. as illustrated in FIG. 3 for an exemplary GSM LA update). After the LA update is finished, the protocol stack handler 910 informs the protocol stack handler 920 that the suspended PS data service can be resumed or restarted (step 1418), enabling the protocol stack handler 920 to enter the in-service state and the protocol stack handler 910 to re-enter the PM mode to make power measurements (step 1420). In the embodiment illustrated in FIG. 14, the basebandchip of the MS is configured to perform the packet-switched (PS) data service associated with the second service network while sacrificing a portion of data transceiving from/to the second service network to monitor the channel (e.g. the BCCH and/or the CPICH) associated with the first service network during the PS data service, so as to maintain mobility in the first service network.

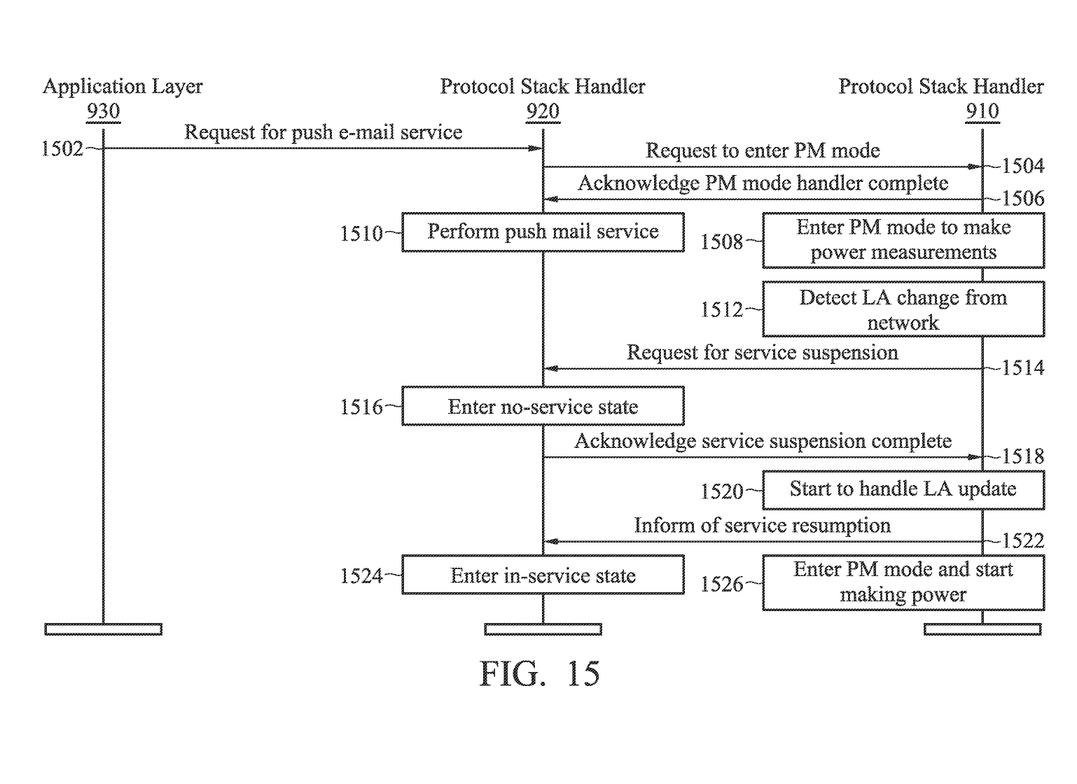

FIG. 15 is a message sequence chart illustrating the coordination of the operations between the protocol stack handlers 910 and 920 according to the embodiment of FIG. 14. Initially, the protocol stack handlers 910 and 920 are in the idle mode, and the protocol stack handler 920 receives a user request from the application layer 930 to perform a PS data service such as a push e-mail service (step 1502). Upon receiving the PS data service request from the application layer 930, the protocol stack handler 920 requests the protocol stack handler 910 to enter a PM mode to stand by and wait for the protocol stack handler 920 to inform for the appropriate timing for making power measurements (step 1504). Reference for detailed descriptions regarding the operations in the PM mode may be made to the aforementioned descriptions relating to FIG. 11 and FIG. 14. After the protocol stack handler 910 has completed the PM mode handler, the protocol stack handler 910 informs the protocol stack handler 920 by sending an acknowledgement for completion of the PM mode handler (step 1506). The protocol stack handler 910 immediately enters the PM mode to make power measurements (step 1508). Upon receiving the acknowledgement for completion of the PM mode handler, the protocol stack handler 920 may start to perform the PS data service of push e-mail or other services (step 1510). Meanwhile, the protocol stack handler 910 in the PM mode detects that the newly camped cell has a new LAI in a cell reselection performed (an LA change) according to the power measurements made in the PM mode (step 1512). For example, the LAI information is broadcasted in the system information in the BCCH for a GSM network or in the Primary Common Control Physical Channel (P-CCPCH) for a WCDMA or a UMTS network, and the protocol stack handler 910 retrieves the LAI information corresponding to the currently camped on cell after each cell reselection, during the PM mode window. The protocol stack handler 910 may request the protocol stack handler 920 to suspend the push e-mail service with the second service network in response to the LA change (step 1514). The protocol stack handler 920 may first determine whether an LA update has higher priority than a PS data service (e.g. by checking a preset user preference for each subscriber identity card or for each PS/CS service). When the CS service of an LA update has a higher priority than a PS data service, the protocol stack handler 920 suspends the PS data service and then enters the no-service state (Step 1516). Upon entering the no-service state, the protocol stack handler 920 further acknowledges the request from the protocol stack handler 910 (Step 1518). Reference for detailed descriptions regarding the operations in the no-service state may be made to the aforementioned descriptions relating to FIG. 12. After receiving the acknowledgement from the protocol stack handler 920, the protocol stack handler 910 requests the radio resource hardware to regain service for the first subscriber identity card and start to handle the CS service of an LA update (step 1520).

Upon completion of the LA update (as illustrated in FIG. 3 for an example of a GSM LA update), the protocol stack handler 910 informs the protocol stack handler 920 that the suspended PS data service may be resumed or restarted (step 1522). Then, the protocol stack handler 920 enters an in-service state to resume or restart the suspended PS data service (step 1524) and the protocol stack handler 910 re-enters the PM mode to make power measurements (step 1526). To resume the PS data service or to enter the in-service state, the protocol stack handler 920 may re-schedule channel tasks, such as listening to the PPCH, PCH or others, causing the MS to receive packet paging messages and allow PRACH, RACH, PACCH, or similar channel allocation procedures to be performed. Alternatively, the protocol stack handler 920 may request to regain control of the radio resource hardware as described previously. In the embodiment illustrated in FIG. 15, the basebandchip of the MS is configured to perform the packet-switched (PS) data service associated with the second service network while sacrificing a portion of data transceiving from/to the second service network to monitor the channel (e.g. the BCCH and/or the CPICH) associated with the first service network during the PS data service, so as to maintain mobility in the first service network.

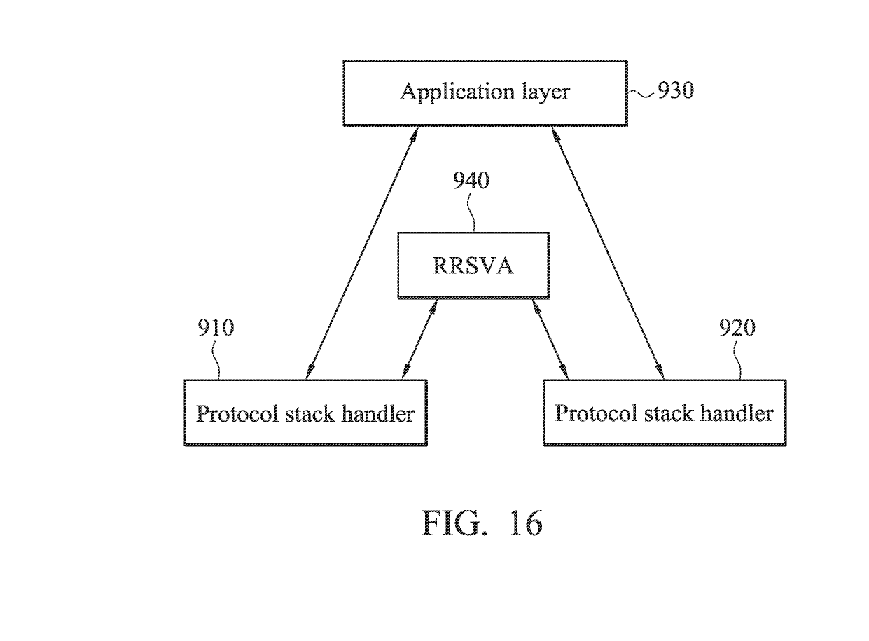

FIG. 16 is a block diagram illustrating the software architecture of an MS according to another embodiment of the invention. Similar to FIG. 8, the exemplary software architecture also contains the protocol stack handlers 910 and 920, and the application layer 930. Additionally, a resource reservation arbitrator (RRSVA) 940 is included, which solves conflicts between the protocol stack handlers 910 and 920 and arbitrates which one of the protocol stack handlers 910 and 920 may occupy the radio resource hardware at a given time. The RRSVA 940 may be implemented in program code and, when the program code is loaded and executed by the processing unit or MCU, granting or rejecting of radio resource requests issued by any of the protocol stack handlers 910 and 920 in terms of predefined rules with the priorities of the requested traffics. For example, CS service traffic and/or data, such as MT traffic and/or an LA update, may have higher priority than PS service traffic, such as traffic for push e-mail, IM, or others. Alternatively, the traffic requested by a specific protocol stack handler may be predefined to have higher priority than the traffic requested by other protocol stack handlers.

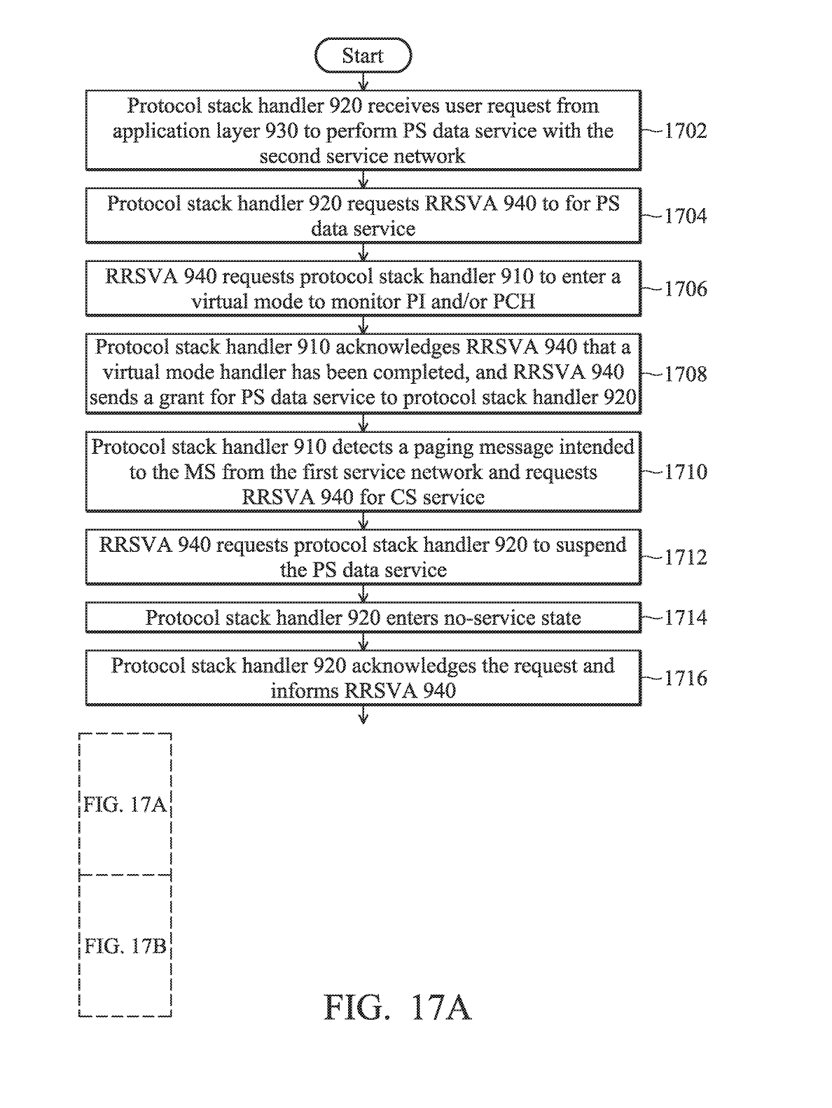

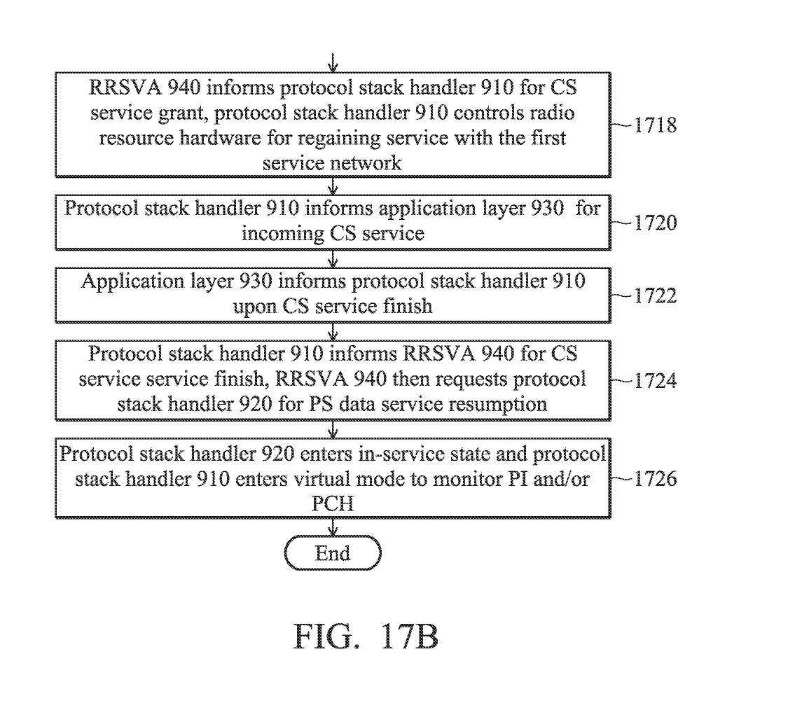

FIG. 17A and FIG. 17B are a flow chart illustrating a method for coordinating the operations between the protocol stack handlers 910 and 920 using the software architecture of FIG. 16 according to an embodiment of the invention. Initially, the protocol stack handlers 910 and 920 are in the idle mode, and the protocol stack handler 920 receives a user request from the application layer 930 to perform a PS data service with the second service network (step 1702). Next, the protocol stack handler 920 requests the RRSVA 940 for a PS data service (step 1704). Upon receiving the PS data service request from the protocol stack handler 920, the RRSVA 940 then requests protocol stack handler 910 to enter a virtual mode to listen to its allocated PCH for paging messages and/or PICH for PIs (step 1706). After the virtual mode handler has been completed, the protocol stack handler 910 informs the RRSVA 940 by sending an acknowledgement for completion of the virtual mode handler (the acknowledgement may contain information about timing for paging occasions associated with the protocol stack handler 910). Upon receiving the acknowledgement, the RRSVA 940 informs the protocol stack handler 920 of the PS data service grant (step 1708). The protocol stack handler 910 immediately enters the virtual mode after sending the acknowledgement, and the protocol stack handler 920 starts to perform the PS data service of push e-mail or other services upon receiving the grant for the PS data service. While the protocol stack handler 920 is performing the PS data service, the protocol stack handler 910 in the virtual mode detects a paging message from the PCH intended for the MS from the first service network, and the protocol stack handler 910 requests the RRSVA 940 for a CS service in response to the received paging message (step 1710). When receiving the CS service request, the RRSVA 940 may first determine whether the CS service (e.g. an MT call or an SMS-MT) has a higher priority than a PS data service. The CS service associated with the first service network may be specified to have higher priority than the PS data service associated with the second service network, or vise versa. When the CS service has a higher priority than a PS data service, the RRSVA 940 requests the protocol stack handler 920 to suspend the PS data service corresponding to the second service network (step 1712). In response to the request, the protocol stack handler 920 suspends the PS data service and then enters the no-service state (Step 1714). Upon entering the no-service state, the protocol stack handler 920 further acknowledges completion of the service suspension and informs the RRSVA 940 (Step 1716). Ways to enter the no-service state may refer to that performed by the protocol stack handler 920 as described previously. The RRSVA 940 informs the protocol stack handler 910 of the CS service grant after receiving the acknowledgement from the protocol stack handler 920. The protocol stack handler 910 requests the radio resource hardware for regaining service with the first service network and starts to handle the CS service in response to the CS service grant (step 1718). Subsequent to step 1718, the protocol stack handler 910 informs the application layer 930 of the incoming CS service such as an MT call as shown in FIG. 2, an MT SMS, or others, corresponding to the first service network (Step 1720). The application layer 930 may signal the user for the incoming CS service by displaying “incoming call” or “incoming SMS” on a screen, a monitor, or others of the MS, and rings or vibrates. After the CS service is finished, the application layer 120 may receive an “end call” signal from the user and inform the protocol stack handler 910 that the CS service has finished (step 1722). Alternatively, the protocol stack handler 910 may receive a signal from the first service network indicating the calling party has ended the call or transmission of the SMS-MT is finished. After being informed that the CS service is finished, the protocol stack handler 910 informs the RRSVA 940 that the CS service is finished, the RRSVA 940 then requests the protocol stack handler 920 to resume or restart the suspended PS data service (step 1724). Subsequently, the protocol stack handler 920 enters the in-service state to resume or restart the suspended PS data service and the protocol stack handler 910 re-enters the virtual mode to listen to its allocated PCH for paging messages and/or PICH for PIs (step 1726). In the embodiment illustrated in FIG. 17, the basebandchip of the MS is configured to perform the packet-switched (PS) data service associated with the second service network while sacrificing a portion of data transceiving from/to the second service network to monitor the channel (e.g. the PICH and/or the PCH) associated with the first service network during the PS data service, so as to receive message from the first service network.

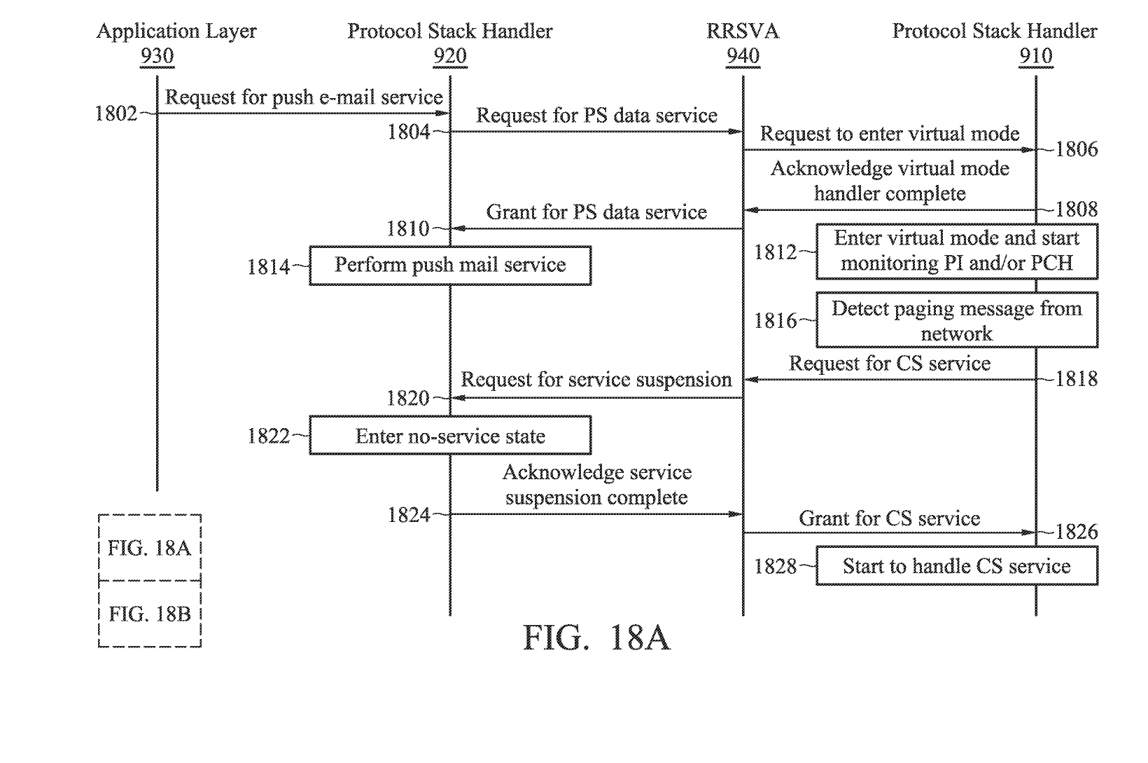

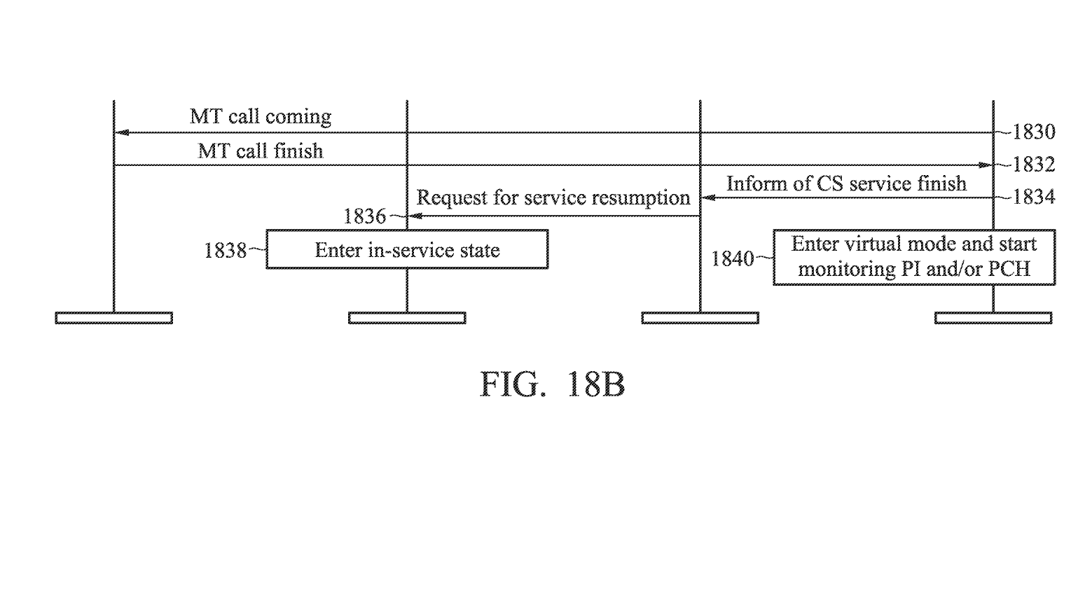

FIGS. 18A and 18B are a message sequence chart illustrating the coordination of the operations between the protocol handlers 910 and 920 according to the embodiment of FIGS. 17A and 17B. Initially, the protocol stack handlers 910 and 920 are in the idle mode, and the protocol stack handler 920 receives a user request from the application layer 930 to perform a push e-mail service (step 1802), the protocol stack handler 920 then sends a request for the PS data service to the RRSVA 940 (step 1804). Upon receiving the PS data service request from the protocol stack handler 920, the RRSVA 940 requests the protocol stack handler 910 to enter a virtual mode to listen to the corresponding PCH for paging messages and/or PICH for PIs (step 1806). Reference may be made to the description of the virtual mode relating to FIG. 12 concerning the behavior of the protocol stack handler 910 in the virtual mode. After the protocol stack handler 910 has completed the virtual mode handler, the protocol stack handler 910 informs the RRSVA 940 by sending an acknowledgement for completion of the virtual mode handler (step 1808), wherein the acknowledgement may contain information about timing for paging occasions associated with the protocol stack handler 910. The RRSVA 940 sends a grant for the PS data service to the protocol stack handler 920 after receiving the acknowledgement (step 1810). The protocol stack handler 910 immediately enters the virtual mode to listen to the corresponding PCH for paging messages and/or PICH for PIs after sending the acknowledgement (step 1812). Alternatively, upon receiving the grant for the PS data service, the protocol stack handler 920 may start to perform the PS data service of push e-mail or other services (step 1814). Meanwhile, the protocol stack handler 910 in the virtual mode detects a paging message from the PCH intended for the MS from the first service network (step 1816). The protocol stack handler 910 requests the RRSVA 940 for a CS service corresponding to the first service network in response to the received paging message (step 1818). When receiving the CS service request, the RRSVA 940 may first determine whether the CS service (e.g. an MT call or an SMS-MT) has a higher priority than a PS data service or whether the service associated with the first service network has a higher priority than the service associated with the second service network, or vise versa. When the CS service has a higher priority than a PS data service, the RRSVA 940 requests the protocol stack handler 920 to suspend the PS data service corresponding to the second service network (step 1820). After receiving the request, the protocol stack handler 920 suspends the PS data service and then enters the no-service state (Step 1822). Upon entering the no-service state, the protocol stack handler 920 further acknowledges completion of the suspended service and informs the RRSVA 940 thereof (Step 1824). For ways to enter the no-service state, reference may be made to that performed by the protocol stack handler 920 as described previously. The RRSVA 940 informs the protocol stack handler 910 of the CS service grant after the acknowledgement from the protocol stack handler 920 is received (step 1826). The protocol stack handler 910 requests the radio resource hardware for regaining service with the first service network and starts to handle the CS service in response to the CS service grant (step 1828). Subsequent to step 1828, the protocol stack handler 910 informs the application layer 930 of the incoming CS services such as an MT call as shown in FIG. 2, an SMS-MT, or others, corresponding to the first subscriber service network (Step 1832). The application layer 930 may signal the user of the incoming CS service by displaying “incoming call” or “incoming SMS” on a screen, a monitor, or others of the MS, and rings or vibrates. When the CS service is finished, the application layer 930 may receive an “end call” signal from the user via a keyboard, touch screen, or other input interface. Upon receiving the user signal indicating that the CS service is finished, the application layer 930 informs the protocol stack handler 910 (step 1832). Alternatively, the protocol stack handler 910 may receive a signal from the first service network indicating that the calling party has ended the call or transmission of the SMS-MT is finished. After being informed that the CS service has finished, the protocol stack handler 910 informs the RRSVA 940 that the CS service has finished (step 1834), the RRSVA 940 then requests the protocol stack handler 920 to resume or restart the suspended PS data service (step 1836). Subsequently, the protocol stack handler 920 enters an in-service state to resume or restart the suspended PS data service (step 1838) and the protocol stack handler 910 re-enters the virtual mode to listen to its allocated PCH for paging messages and/or PICH for PIs (step 1840). In the embodiment illustrated in FIG. 18, the basebandchip of the MS is configured to perform the packet-switched (PS) data service associated with the second service network while sacrificing a portion of data transceiving from/to the second service network to monitor the channel (e.g. the PICH and/or the PCH) associated with the first service network during the PS data service, so as to receive message from the first service network.

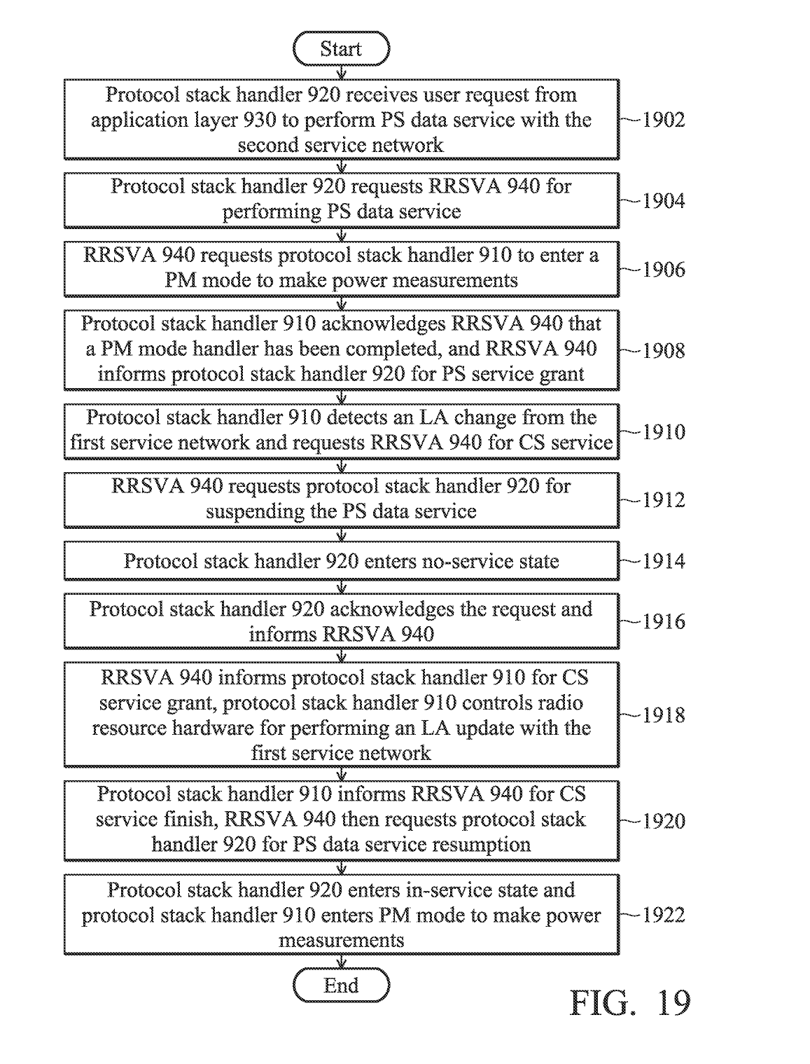

FIG. 19 is a flow chart illustrating the method for coordinating the operations between the protocol stack handlers 910 and 920 using the software architecture of FIG. 16 according to another embodiment of the invention. Initially, the protocol stack handlers 910 and 920 are in the idle mode, and the protocol stack handler 920 receives a user request from the application layer 930 to perform a PS data service with the second subscriber identity card (step 1902). Next, the protocol stack handler 920 requests the RRSVA 940 for a PS data service (step 1904). Upon receiving the PS data service request from the protocol stack handler 920, the RRSVA 940 then requests the protocol stack handler 910 to enter a power measurement (PM) mode (step 1906). Description concerning the behavior of the protocol stack handler 910 in the PM mode may be made to the description of the PM mode relating to FIG. 11 and FIG. 14. After the PM mode handler has been completed, the protocol stack handler 910 informs the RRSVA 940 for completion of the PM mode handler by sending an acknowledgement. Upon receiving the acknowledgement, the RRSVA 940 informs the protocol stack handler 920 of the PS data service grant (step 1908). The protocol stack handler 910 immediately enters the PM mode to make power measurements after sending the acknowledgement, and the protocol stack handler 920 starts to perform the PS data service of push e-mail or other services upon receiving the grant for the PS data service. While the protocol stack handler 920 performs PS data services, the protocol stack handler 910 performs a cell reselection procedure according to the power measurements made in the PM mode, and detects that the newly camped cell has a new LAI (an LA change). The protocol stack handler 910 requests the RRSVA 940 for a CS service of an LA update in response to the detected new LAI (step 1910). Upon receiving the CS service request, the RRSVA 940 may first determine whether the requested CS service of the LA update has a higher priority than the PS data service. When the CS service of the LA update has a higher priority than the PS data service, the RRSVA 940 requests the protocol stack handler 920 to suspend the PS data service corresponding to the second service network (step 1912). In response to the request, the protocol stack handler 920 suspends the PS data service and then enters the no-service state (Step 1914). Upon entering the no-service state, the protocol stack handler 920 further acknowledges completion of the suspended service and informs the RRSVA 940 thereof (Step 1916). Description concerning the ways to enter the no-service state may be made to that performed by the protocol stack handler 920 as described previously. The RRSVA 940 informs the protocol stack handler 910 of the CS service grant after receiving the acknowledgement from the protocol stack handler 920. The protocol stack handler 910 requests the radio resource hardware to regain service for the first subscriber identity card and starts to handle the LA update in response to the CS service grant (step 1918). After the LA update is finished, the protocol stack handler 910 informs the RRSVA 940 that the CS service is finished, and the RRSVA 940 then requests the protocol stack handler 920 to resume or restart the suspended PS data service (step 1920). Subsequently, the protocol stack handler 920 enters the in-service state to resume or restart the suspended PS data service and the protocol stack handler 910 re-enters the PM mode to make power measurements (step 1922). In the embodiment illustrated in FIG. 19, the basebandchip of the MS is configured to perform the packet-switched (PS) data service associated with the second service network while sacrificing a portion of data transceiving from/to the second service network to monitor the channel (e.g. the BCCH and/or the CPICH) associated with the first service network during the PS data service, so as to maintain mobility in the first service network.

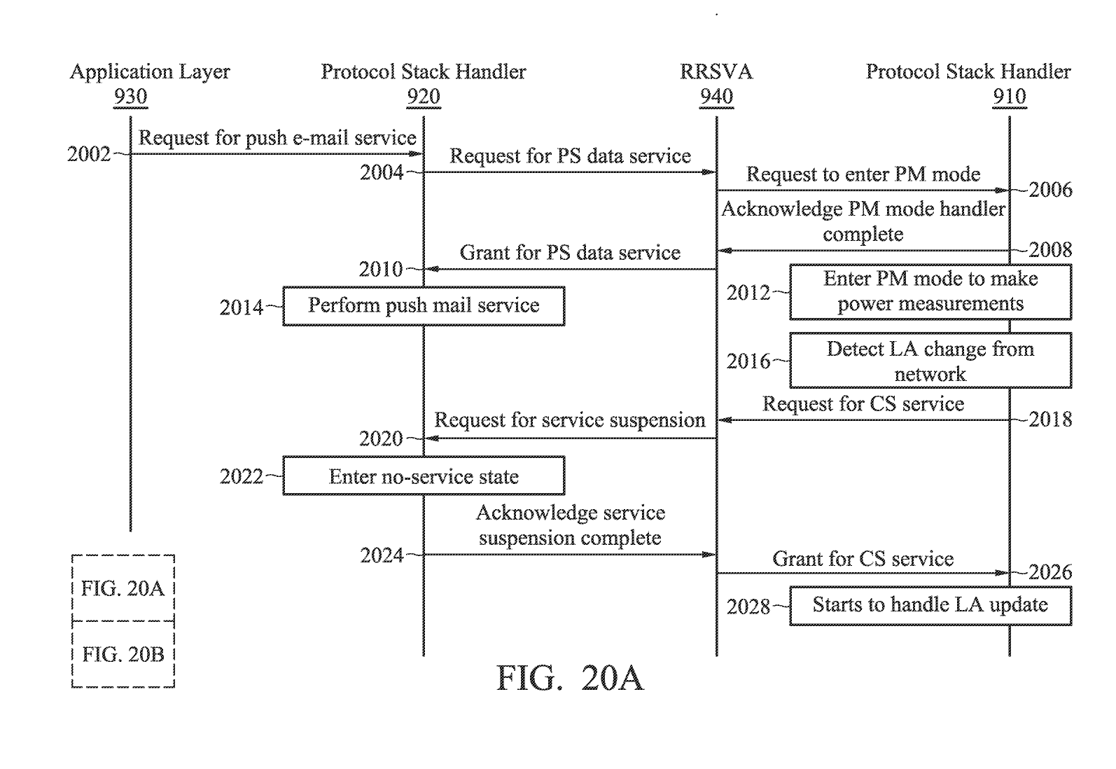

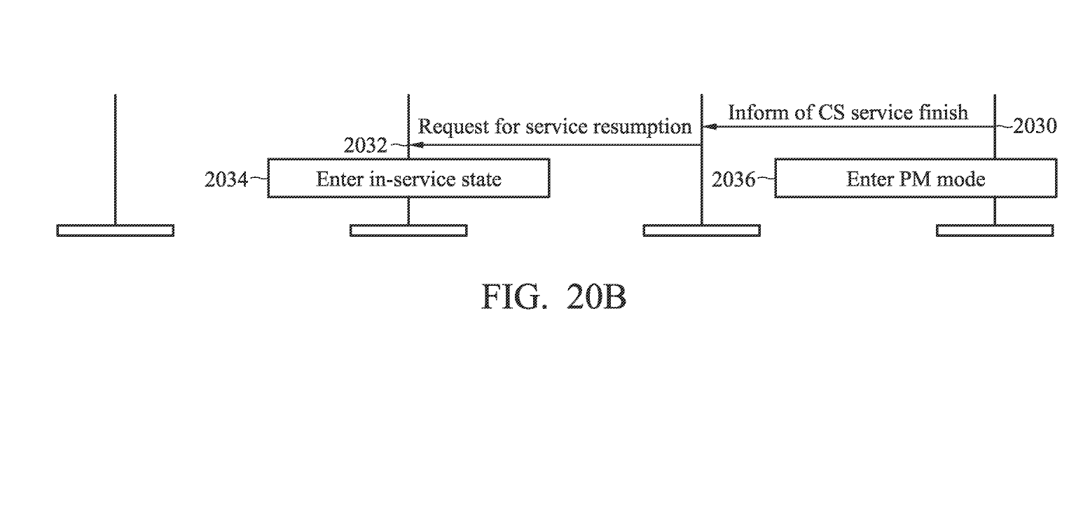

FIGS. 20A and 20B is a message sequence chart illustrating the coordination of the operations between the protocol stack handlers 910 and 920 according to the embodiment of FIG. 19. Initially, the protocol stack handlers 910 and 920 are in the idle mode, and the protocol stack handler 920 receives a user request from the application layer 930 to perform a PS data service such as a push e-mail service (step 2002). After, the protocol stack handler 920 then sends a request for the PS data service to the RRSVA 940 (step 2004). Upon receiving the PS data service request from the application layer 930, the RRSVA 940 requests the protocol stack handler 910 to enter a PM mode to make power measurements (step 2006). After the protocol stack handler 910 has completed the PM mode handler, the protocol stack handler 910 informs the RRSVA 940 by sending an acknowledgement for completion of the PM mode handler (step 2008). Upon receiving the acknowledgement, the RRSVA 940 informs the protocol stack handler 920 of the PS data service grant (step 2010). The protocol stack handler 910 immediately enters the PM mode to make power measurements after sending the acknowledgement (step 2012). Alternatively, upon receiving the grant for the PS data service, the protocol stack handler 920 starts to perform the PS data service of push e-mail or other services (step 2014). While the protocol stack handler 920 performs PS data services, the protocol stack handler 910 performs a cell reselection procedure according to the power measurements made in the PM mode, and detects that the newly camped cell has a new LAI (an LA change) (step 2016), wherein the protocol stack handler 910 requests the RRSVA 940 for a CS service in response to the detected new LAI (step 2018). Meanwhile, the protocol stack handler 910 in the virtual mode detects a paging message from the PCH and/or a PI from PICH intended for the MS from the associated service network (step 1816). Upon receiving the CS service request, the RRSVA 940 requests the protocol stack handler 920 to suspend the PS data service corresponding to the second service network (step 2020). In response to the request, the protocol stack handler 920 suspends the PS data service and then enters the no-service state (Step 2022). Upon entering the no-service state, the protocol stack handler 920 further acknowledges completion of the suspended service requested from the RRSVA 940 and informs the RRSVA 940 thereof (Step 2024). Description concerning ways to enter the no-service state may be made to that performed by the protocol stack handler 920 as described previously. The RRSVA 940 informs the protocol stack handler 910 of the CS service grant after receiving the acknowledgement from the protocol stack handler 920 (step 2026). The protocol stack handler 910 requests the radio resource hardware for regaining service with the first service network and starts to handle the LA update in response to the CS service grant (step 2028). After the LA update is finished, the protocol stack handler 910 informs the RRSVA 940 that the CS service has finished (step 2030). Next, the RRSVA 940 requests the protocol stack handler 920 to resume or restart the suspended PS data service (step 2032). Subsequently, the protocol stack handler 920 enters the in-service state to resume or restart the suspended PS data service and the protocol stack handler 910 re-enters the PM mode to make power measurements (step 2034 and 2036). In the embodiment illustrated in FIG. 20, the basebandchip of the MS is configured to perform the packet-switched (PS) data service associated with the second service network while sacrificing a portion of data transceiving from/to the second service network to monitor the channel (e.g. the BCCH and/or the CPICH) associated with the first service network during the PS data service, so as to maintain mobility in the first service network.

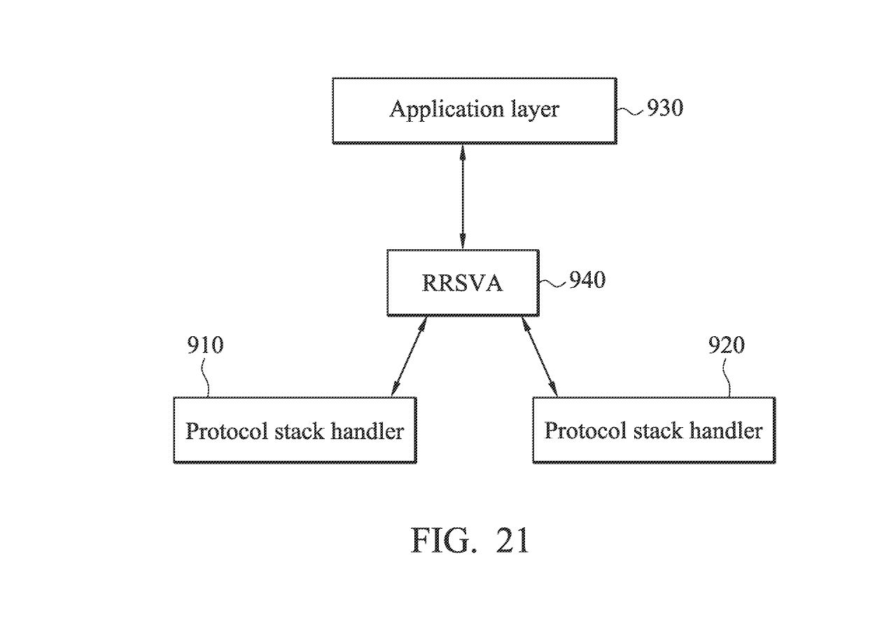

FIG. 21 is a block diagram illustrating the software architecture of an MS according to yet another embodiment of the invention. Similar to FIG. 16, the exemplary software architecture also contains the protocol stack handlers 910 and 920, the application layer 930, and the RRSVA 940. However, the RRSVA 940 coordinates all the operations between the application layer 930, and the protocol stack handlers 910 and 920.

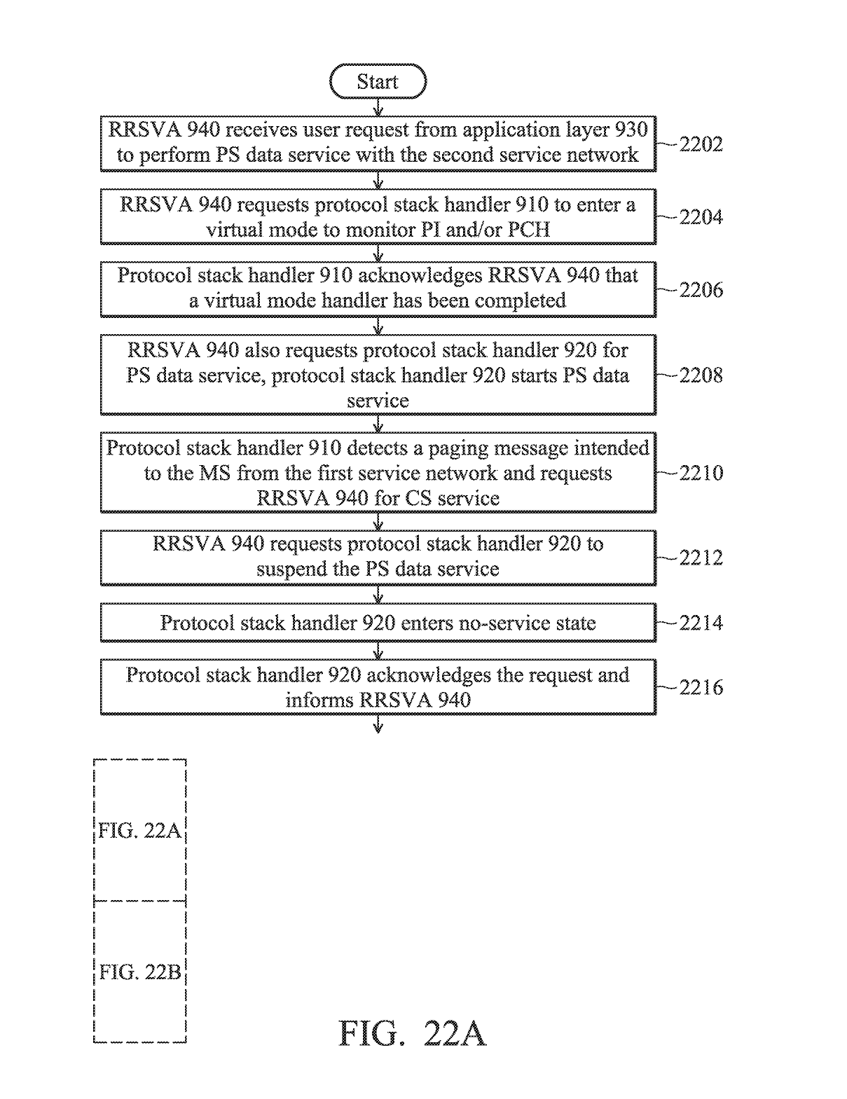

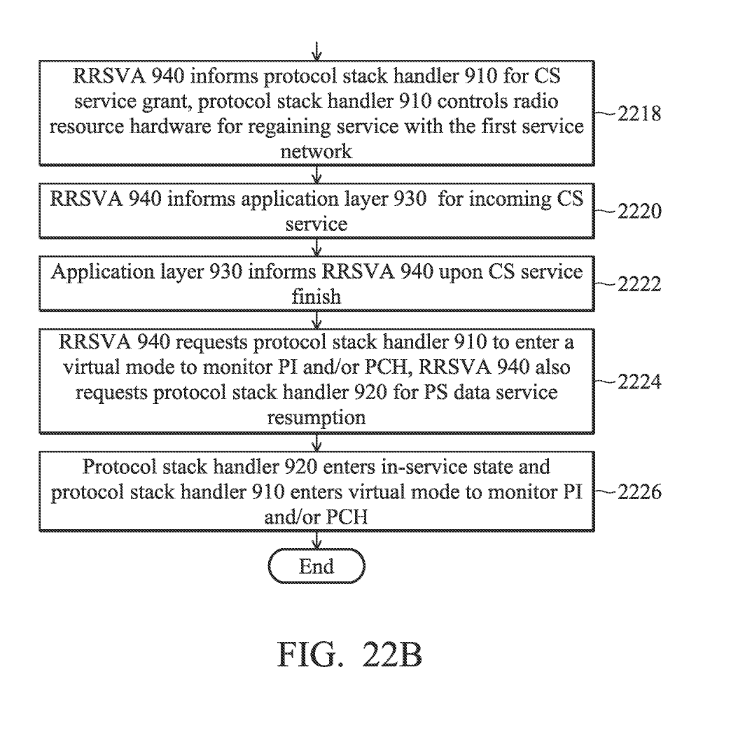

FIGS. 22A and 22B are a flow chart illustrating a method for coordinating the operations between the protocol stack handlers 910 and 920 using the software architecture of FIG. 21 according to an embodiment of the invention. Initially, the protocol stack handlers 910 and 920 are in the idle mode, and the RRSVA 940 receives a user request from the application layer 930 to perform a PS data service (step 2202). Next, the RRSVA 940 requests the protocol stack handlers 910 to enter a virtual mode to listen to its allocated PCH for paging messages and/or PICH for PIs (step 2204), and the protocol stack handler 910 informs the RRSVA 940 after the virtual mode handler has been completed by sending an acknowledgement for virtual mode handler complete (step 2206). The protocol stack handler 910 immediately enters the virtual mode after sending the acknowledgement. The RRSVA 940 then requests the protocol stack handler 920 to start the PS data service, wherein the protocol stack handler 920 starts to perform the PS data service upon receiving the request for the PS data service and the protocol stack handler 920 may feedback to the RRSVA 940 to acknowledge the PS data service request (step 2208). Steps 2204 to 2208 may be implemented in different orders. In an embodiment, the RRSVA 940 may be configured to send a request to the protocol stack handler 910 for entering the virtual mode and send a request to the protocol stack handler 920 for the PS data service at the same time, or alternatively, the RRSVA 940 may be configured to send a request to the protocol stack handler 920 for the PS data service prior to sending a request to the protocol stack handler 910 for entering the virtual mode. Subsequent to step 2208, the protocol stack handler 910 in the virtual mode detects a paging message from the PCH intended for the MS from the associated service network, and the protocol stack handler 910 requests the RRSVA 940 for a CS service in response to the received paging message (step 2210). Upon receiving the CS service request, the RRSVA 940 requests the protocol stack handler 920 to suspend the PS data service corresponding to the second service network (step 2212). In response to the request, the protocol stack handler 920 suspends the PS data service and then enters the no-service state (Step 2214), the protocol stack handler 920 further acknowledges completion of service suspension and informs the RRSVA 940 thereof (Step 2216). The RRSVA 940 informs the protocol stack handler 910 of the CS service grant after receiving the acknowledgement from the protocol stack handler 920. The protocol stack handler 910 requests the radio resource hardware for regaining service for the first subscriber identity card and starts to handle the CS service in response to the CS service grant (step 2218). Subsequent to step 2218, the RRSVA 940 informs the application layer 930 of the incoming CS (Step 2220). The application layer 930 may signal the user of the incoming CS service by displaying “incoming call” or “incoming SMS” on a screen, a monitor, or others of the MS, and rings or vibrates. When the CS service is finished, the application layer 120 may receive an “end call” signal from the user and inform the RRSVA 940 that the CS service has finished (step 2222). Alternatively, the protocol stack handler 910 may receive a signal from the first service network indicating that the calling party has ended a call or transmission of the SMS-MT is finished and inform the RRSVA 940 thereof. After the RRSVA is informed that the CS service is finished, the RRSVA 940 then requests the protocol stack handler 910 to enter the virtual mode, and the RRSVA 940 also requests the protocol stack handler 920 to resume or restart the suspended PS data service (step 2224). Subsequently, the protocol stack handler 920 enters the in-service state, and the protocol stack handler 910 re-enters the virtual mode (step 2226). In the embodiment illustrated in FIG. 22, the basebandchip of the MS is configured to perform the packet-switched (PS) data service associated with the second service network while sacrificing a portion of data transceiving from/to the second service network to monitor the channel (e.g. the PICH and/or the PCH) associated with the first service network during the PS data service, so as to receive message from the first service network.

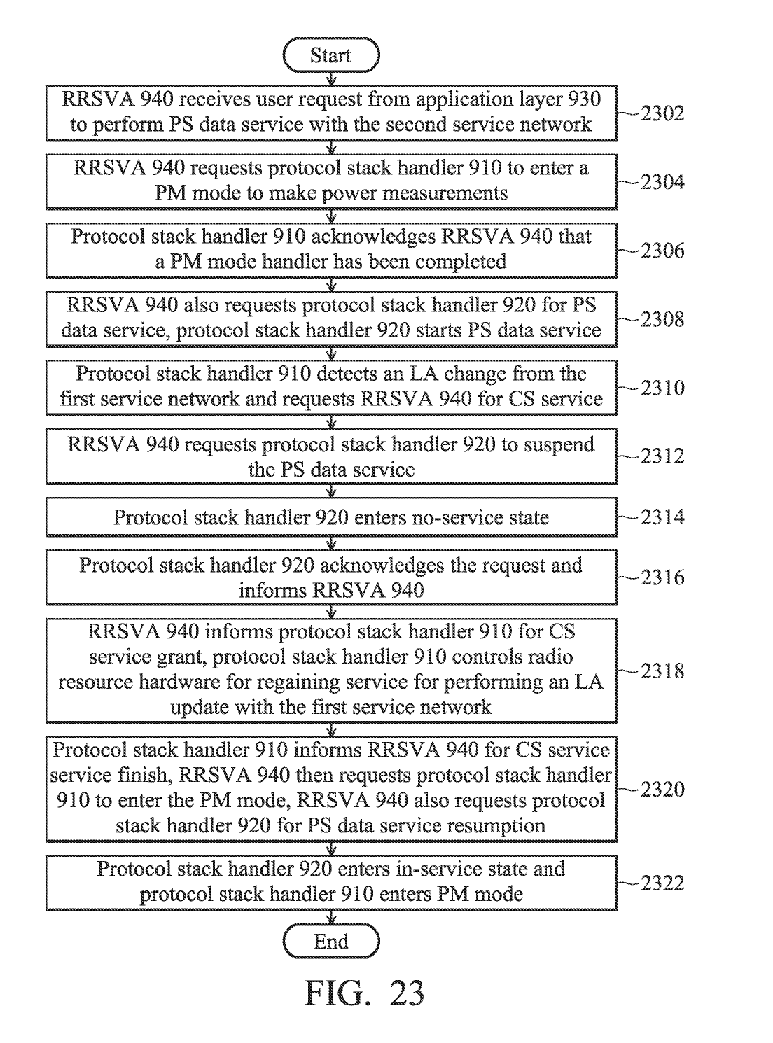

FIG. 23 is a flow chart illustrating the method for coordinating the operations between the protocol stack handlers 910 and 920 using the software architecture of FIG. 21 according to another embodiment of the invention. Initially, the protocol stack handlers 910 and 920 are in the idle mode, and the RRSVA 940 receives a user request from the application layer 930 to perform a PS data service with the second subscriber identity card (step 2302). Next, the RRSVA 940 requests the protocol stack handlers 910 to enter a PM mode to make power measurements (step 2304), and the protocol stack handler 910 informs the RRSVA 940 after the PM mode handler has been completed by sending an acknowledgement for completion of the PM mode handler (step 2306). The protocol stack handler 910 immediately enters the PM mode after sending the acknowledgement. The RRSVA 940 then requests the protocol stack handler 920 to start the PS data service, wherein the protocol stack handler 920 starts to perform the PS data service upon receiving the request for the PS data service, and the protocol stack handler 920 may feedback to the RRSVA 940 to acknowledge the PS data service request (step 2308). Steps 2304 to 2308 may be implemented in different orders, in an embodiment, the RRSVA 940 may be configured to send a request to the protocol stack handler 910 for entering PM mode and send a request to the protocol stack handler 920 for the PS data service at the same time, or alternatively, the RRSVA 940 may be configured to send a request to the protocol stack handler 920 for the PS data service prior to sending a request to the protocol stack handler 910 for entering PM mode. Subsequent to step 2308, the protocol stack handler 910 performs a cell reselection procedure according to the power measurements made in the PM mode, and detects that the newly camped cell has a new LAI (an LA change), wherein the protocol stack handler 910 requests the RRSVA 940 for a CS service in response to the detected new LAI (step 2310). Upon receiving the CS service request, the RRSVA 940 requests the protocol stack handler 920 to suspend the PS data service with the second service network (step 2312). In response to the request, the protocol stack handler 920 suspends the PS data service and then enters the no-service state (Step 2314). Upon entering the no-service state, the protocol stack handler 920 further acknowledges completion of service suspension and informs the RRSVA 940 thereof (Step 2316). The RRSVA 940 informs the protocol stack handler 910 of the CS service grant after receiving the acknowledgement from the protocol stack handler 920. The protocol stack handler 910 requests the radio resource hardware for regaining service for the first subscriber identity card and starts to handle the LA update in response to the CS service grant (step 2318). After the LA update is finished, the protocol stack handler 910 informs the RRSVA 940 that the CS service is finished, wherein the RRSVA 940 then requests the protocol stack handler 910 to enter the PM mode, and the RRSVA 940 also requests the protocol stack handler 920 to resume or restart the suspended PS data service (step 2320). Subsequently, the protocol stack handler 920 enters the in-service state to resume or restart the suspended PS data service and the protocol stack handler 910 re-enters the PM mode to make power measurements (step 2322). In the embodiment illustrated in FIG. 23, the basebandchip of the MS is configured to perform the packet-switched (PS) data service associated with the second service network while sacrificing a portion of data transceiving from/to the second service network to monitor the channel (e.g. the BCCH and/or the CPICH) associated with the first service network during the PS data service, so as to maintain mobility in the first service network.

While the invention has been described by way of example and in terms of preferred embodiment, it is to be understood that the invention is not limited thereto. Those who are skilled in this technology can still make various alterations and modifications without departing from the scope and spirit of this invention. For example, the software architectures of FIGS. 8, 16, and 22 may each be implemented in program code stored in a machine-readable storage medium, such as a magnetic tape, semiconductor, magnetic disk, optical disc (e.g., CD-ROM, DVD-ROM, etc.), or others. A Web server may store the software architectures of FIGS. 8, 16, and 22 in a machine-readable storage medium, which can be downloaded by a client computer through the Internet. When loaded and executed by the processing unit or MCU, the program code may perform the methods of FIG. 12, 14, 17, 19, 23 or 24, respectively corresponding to the software architectures of FIGS. 8, 16, and 22. Although the embodiments described above employ the GSM/GPRS, WCDMA and/or UMTS based technologies, the invention is not limited thereto. The embodiments may also be applied to other telecommunication network technologies, such as CDMA 2000, and TD-SCDMA, WiMAX, LTE, and TD-LTE technologies. Therefore, the scope of the present invention shall be defined and protected by the following claims and their equivalents.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A wireless communication device for coordinating operations between a circuit switched (CS) service and a packet switched (PS) service with respective service networks, comprising:
a baseband chip performing a packet switched (PS) data service associated with a second service network, sacrificing a portion of data transceiving from/to the second service network to monitor a channel associated with a first service network during the PS data service, so as to receive message from the first service network or maintain mobility in the first service network.

2. The wireless communications device of claim 1, wherein the baseband chip further receives a request for a circuit switched (CS) service associated with the first service network from the channel, suspends the PS data service in response to the request, and performs the CS service with the first service network when the PS data service is suspended.

3. The wireless communications device of claim 2, wherein the baseband chip further resumes the PS data service associated with the second service network when the CS service is finished.

4. The wireless communications device of claim 2, wherein the baseband chip further suspends the PS data service when CS service having a higher priority than PS service is predefined.

5. The wireless communications device of claim 2, wherein the baseband chip removes scheduled channel tasks for suspending the PS data service, such that no packet paging message from the second service network is received, and uplink channel allocation associated with the second service network is hindered.

6. The wireless communications device of claim 3, wherein the baseband chip detaches an attached data service for suspending the PS data service, and attaches a detached data service for resuming the PS data service.

7. The wireless communications device of claim 1, wherein the CS service is a Mobile-Terminated (MT) service.

8. The wireless communications device of claim 7, wherein the baseband chip further informs a user via a man-machine interface (MMI) for the MT service.

9. The wireless communications device of claim 7, wherein the baseband chip monitors the channel according to a paging occasion associated with a camped cell within the first service network.

10. The wireless communications device of claim 7, wherein the channel is a paging channel (PCH).

11. The wireless communications device of claim 2, wherein the CS service is a Location Area (LA) update.

12. The wireless communications device of claim 11, wherein the baseband chip monitors the channel associated with the first service network when the baseband chip is not transmitting or receiving PS data with the second service network.

13. The wireless communications device of claim 1, wherein the baseband chip monitors the channel comprising making a power measurement of the channel for a candidate cell.

14. The wireless communications device of claim 13, wherein the channel is a Broadcast Control Channel (BCCH) or a Common Pilot Channel (CPICH).

15. The wireless communications device as claimed in claim 1, wherein the first service network corresponds to a first subscriber identity card and the second service network corresponds to a second subscriber identity card.

16. A wireless communications method for coordinating operations between a circuit switched (CS) service and a packet switched (PS) service with respective service networks in a wireless communications device, comprising:
performing, by a baseband chip, a packet switched (PS) data service associated with a second service network;
sacrificing, by a baseband chip, a portion of data transceiving from/to the second service network to monitor a channel associated with a first service network during the PS data service, so as to receive message from the first service network or maintain mobility in the first service network.

17. The wireless communications method of claim 16 further comprising:
receiving, by the baseband chip, a request for the circuit switched (CS) service associated with the first service network from the channel;
suspending, by the baseband chip, the PS data service in response to the request; and
performing, by the baseband chip, the CS service associated with the first service network by the baseband chip when the PS data service is suspended.

18. The wireless communications method of claim 17, further comprising resuming, by the baseband chip, the PS data service associated with the second service network when the CS service is finished.

19. The wireless communications method of claim 17, further comprising suspending, by the baseband chip, the PS data service when the CS service having a higher priority than the PS data service is predefined.

20. The wireless communications method of claim 17, further comprising removing scheduled channel tasks for suspending the PS data service by the baseband chip, such that no packet paging message from the second service network is received, and uplink channel allocation associated with the second service network is hindered.

21. The wireless communications method of claim 18, further comprising detaching, by the baseband chip, an attached data service for suspending the PS data service, and attaching, by the baseband chip, a detached data service for resuming the PS data service.

22. The wireless communications method of claim 16, wherein the CS service is a Mobile-Terminated (MT) service.

23. The wireless communications method of claim 22, wherein the baseband chip further informs a user via a man-machine interface (MMI) for the MT service.

24. The wireless communications method of claim 22 further comprising monitoring of the channel, by the baseband chip, according to a paging occasion associated with a camped cell within the first service network.

25. The wireless communications method of claim 22, wherein the channel is a paging channel (PCH).

26. The wireless communications method of claim 16, wherein the CS service is a Location Area (LA) update.

27. The wireless communications method of claim 26 further comprising monitoring of the channel with the first service network by the baseband chip when the baseband chip is not transmitting or receiving PS data with the second service network.

28. The wireless communications method of claim 16, wherein the monitoring of the channel comprises make a power measurement of the channel for a candidate cell.

29. The wireless communications method of claim 28, wherein the channel is a Broadcast Control Channel (BCCH) or a Common Pilot Channel (CPICH).

30. The wireless communications method of claim 16, wherein the first service network corresponds to a first subscriber identity card and the second service network corresponds to a second subscriber identity card.
